(19) United States
(12) Patent Application Publication
(10) Pub. No.: US 2007/0095630 A1
(43) Pub. Date: May 3, 2007

(54) METHOD AND APPARATUS FOR DOCUMENT IDENTIFICATION AND AUTHENTICATION

(75) Inventors: Douglas Mennie, BARRINGTON, IL (US); Richard Mazur, PALATINE, IL (US); John Radomski, LOMBARD, IL (US); Frederick Chamberlain IV, LEUCADIA, CA (US); Jay Freeman, Encenitas, CA (US); Kent Gandola, SAN DIEGO, CA (US)

Correspondence Address: CUMMINS-ALLISON CORP.;C/O JENKENS & GILCHRIST, 225 WEST WASHINGTON STREET, SUITE 2600, CHICAGO, IL, 60606, US

(73) Assignee: CUMMINS-ALLISON CORP., MT. PROSPECT, IL (US)

(21) Appl. No.: 09/684,103

(22) Filed: Oct. 5, 2000

Related U.S. Application Data
Application No. 09/684,103 is a continuation-in-part of application No. 09/450,187, filed on Nov. 29, 1999, now abandoned.
Application No. 09/450,187 is a continuation of application No. 08/800,053, filed on Feb. 14, 1997, now Pat. No. 5,992,601.
(60) Provisional application No. 60/018,563, filed on May 29, 1996.
(60) Provisional application No. 60/011,688, filed on Feb. 15, 1996.

(51) Int. Cl. G07F 7/04

(52) U.S. Cl. 194/206

(57) ABSTRACT

A currency evaluation device for receiving a currency bill having a magnetic attribute and evaluating the currency bill comprises a magnetic scanhead disposed adjacent to a bill evaluation region, a memory adapted to store master magnetic characteristic information corresponding to a plurality of types of currency bills, and an evaluating unit. The scanhead includes a plurality of closely spaced magnetic sensors each adapted to detect the presence of a magnetic attribute of the bill. The plurality of magnetic sensors cover a substantial portion of a dimension of a bill. The scanhead is adapted to retrieve magnetic characteristic information from the currency bill. The evaluating unit is adapted to evaluate the currency bill by comparing the retrieved magnetic characteristic information to the stored master magnetic characteristic information and to generate an error signal when the retrieved magnetic characteristic information does not favorably compare to the stored master magnetic characteristic information.

### CROSS-REFERENCE TO RELATED APPLICATIONS

This application is a continuation-in-part of copending U.S. patent application Ser. No. 09/450,187 filed Nov. 29, 1999. U.S. patent application Ser. No. 09/450,187 is a continuation of U.S. Pat. No. 5,992,601 filed Feb. 14, 1997. U.S. Pat. No. 5,992,601 claims the benefit of Provisional Patent Application Ser. Nos. 60/011,688 filed Feb. 15, 1996, now abandoned, and 60/018,563 filed May 29, 1996, now abandoned.

### FIELD OF THE INVENTION

The present invention relates, in general, to document identification. More specifically, the present invention relates to an apparatus and method for detecting magnetic attributes of currency bills exhibiting magnetic properties.

### BACKGROUND OF THE INVENTION

A variety of techniques and apparatus have been used to satisfy the requirements of automated currency handling systems. At the lower end of sophistication in this area of technology are systems capable of handling only a specific type of currency, such as a specific dollar denomination, while rejecting all other currency types. At the upper end are complex systems which are capable of identifying and discriminating among and automatically counting multiple currency denominations.

Recent currency discriminating systems rely on comparisons between a scanned pattern obtained from a subject bill and sets of stored master patterns for the various denominations among which the system is designed to discriminate. For example, it has been found that scanning U.S. bills of different denominations along a central portion thereof provides scanning patterns sufficiently divergent to enable accurate discrimination between different denominations. Such a discrimination device is disclosed in U.S. Pat. No. 5,295,196. However, currencies of other countries can differ from U.S. currency and from each other in a number of ways. For example, while all denominations of U.S. currencies are the same size, in many other countries currencies vary in size by denomination. Furthermore, there is a wide variety of bill sizes among different countries. In addition to size, the color of currency can vary by country and by denomination. Likewise, many other characteristics may vary between bills from different countries and of different denominations. Such as, for example, the placement of a currency thread within the currency bills. The location of a security thread within the currency bill can vary for different countries and different denominations as well as for different series of denominations.

Many types of currency bills possess magnetic attributes exhibiting magnetic properties which can be used to uniquely identify and/or authentic the currency bills. Examples of magnetic attributes include security threads exhibiting magnetic properties and ink exhibiting magnetic properties with which portions of some bills are printed. Many of these magnetic attributes have a very small dimension(s). For example, many security threads have a width of about one millimeter. In prior art currency devices, the ability of the device to detect the presence of a magnetic attribute was dependent on a sensor pre-positioned along a bill transport path corresponding to a known location on or within a currency bill. Therefore, a new sensor would be added so that the device could evaluate other types of currency bills having magnetic attributes position in other locations.

### SUMMARY OF THE INVENTION

A currency evaluation device for receiving a currency bill having a magnetic attribute and evaluating the currency bill comprises a magnetic scanhead disposed adjacent to a bill evaluation region, a memory adapted to store master magnetic characteristic information corresponding to a plurality of types of currency bills, and an evaluating unit. The scanhead includes a plurality of closely spaced magnetic sensors each adapted to detect the presence of a magnetic attribute of the bill. The plurality of magnetic sensors cover a substantial portion of a dimension of a bill. The scanhead is adapted to retrieve magnetic characteristic information from the currency bill. The evaluating unit is adapted to evaluate the currency bill by comparing the retrieved magnetic characteristic information to the stored master magnetic characteristic information and to generate an error signal when the retrieved magnetic characteristic information does not favorably compare to the stored master magnetic characteristic information.

### BRIEF DESCRIPTION OF THE DRAWINGS

Other objects and advantages of the invention will become apparent upon reading the following detailed description in conjunction with the drawings in which:

FIG. 1 is a perspective view of a currency scanning and counting machine embodying the present invention;

FIG. 2 is a functional block diagram illustrating a currency discriminating system having a single scanhead;

FIG. 3 is a functional block diagram of an alternate currency scanning and counting machine;

FIG. 4a is a diagrammatic perspective illustration of the successive areas scanned during the traversing movement of a single bill across an optical sensor according to one embodiment of the present invention;

FIG. 4b is a perspective view of a bill and a preferred area to be optically scanned on the bill;

FIG. 4c is a diagrammatic side elevation view of the scan area to be optically scanned on a bill according to one embodiment of the present invention;

FIG. 5 is a top view of a staggered scanhead arrangement according to one embodiment of the present invention;

FIGS. 6a and 6b are a flowchart of the operation of a currency discrimination system according to one embodiment of the present invention;

FIG. 7 is a block diagram of one embodiment of a system for detecting counterfeit currency according to the present invention;

FIG. 8 is a flow diagram that illustrates the operation of a counterfeit detector according to an embodiment of the present invention;

FIG. 9 is a graphical representation of the magnetic data points generated by both a genuine one hundred dollar bill and a counterfeit one hundred dollar bill;

FIG. 10 is a functional block diagram illustrating a currency discriminating and authenticating system according to the present invention;

FIGS. 11a and 11b comprise a flowchart illustrating the sequence of operations involved in implementing the discrimination and authentication system of FIG. 15;

FIGS. 12a and 12b are top views of U.S. currency illustrating the location of various magnetic features;

FIGS. 13-15 are top views of sensor arrangements according to several embodiments of the present invention;

FIGS. 16a and 16b are top views of U.S. currency illustrating various scanning areas according to an embodiment;

FIGS. 17a-17d are top views of sensor arrangements according to several embodiments of the present invention;

FIG. 18 is a top view of thread sensors of a document discriminating/authenticating system according to one embodiment of the present invention;

FIG. 19 is a top view of a magnetic scanhead of a document discriminating/authenticating system according to one embodiment of the present invention;

FIG. 20 is a flowchart illustrating the steps performed in determining the denomination of a bill based on the location of a security thread;

FIG. 21 is a flowchart illustrating the steps performed in magnetically determining the denomination of a bill;

FIG. 22 is a flowchart illustrating the steps performed in optically denominating a bill and magnetically authenticating the bill;

FIG. 23 is a flowchart illustrating the steps performed in magnetically denominating a bill and optically authenticating the bill; and

FIG. 24 is a flowchart illustrating the steps performed in denominating a bill both optically and magnetically.

### DETAILED DESCRIPTION OF THE EMBODIMENTS

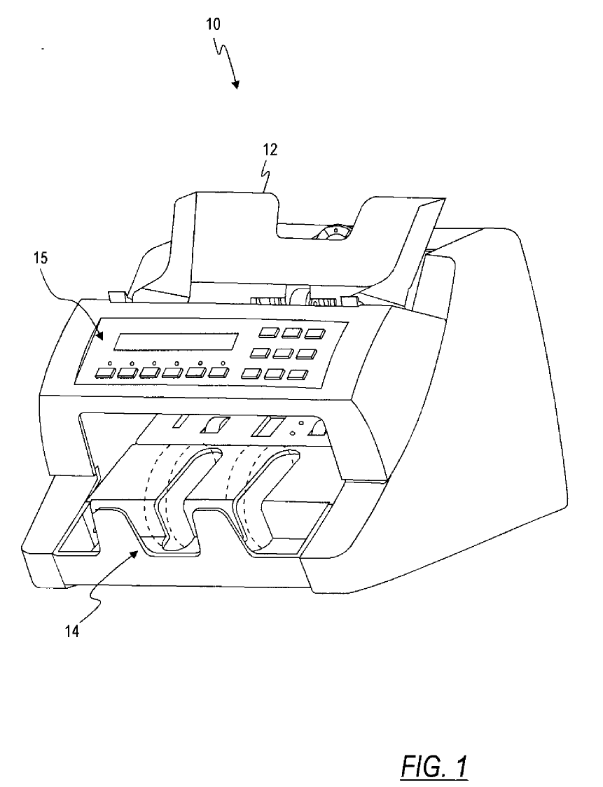

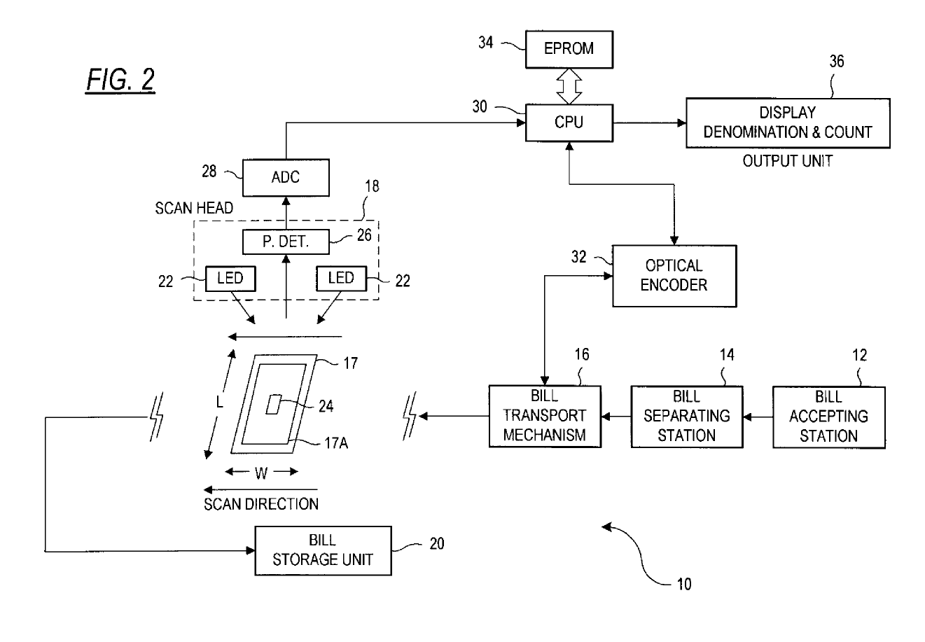

According to one embodiment of the present invention, multiple scanheads or sensors per side are used to scan a bill. FIG. 1 is a perspective view of a currency processing device 10 embodying the present invention according to one embodiment. Currency bills are fed, one by one, form a stack of currency bills in an input receptacle 12 into a transport mechanism (not shown). The transport mechanism guides the bills to a output receptacle 14. Before reaching the output receptacle 20, the transport mechanism guides the bills past an evaluation region (not shown), which comprises one or more sensors, where a bill can be for example, analyzed, authenticated denominated, counted, and/or otherwise processed. The results of the above process or processes are communicated to a user of the currency processing device 10 via a user interface 15. The results of the above process or processes may be used to determine to operation of the currency handing device 10 (e.g. whether to suspend operation of the device when a counterfeit bills is detected). While the currency processing device 10 illustrated in FIG. 1 contains only one output receptacle 16, the present invention is applicable to currency processing machines containing more than one output receptacle such as the multi-pocket currency handing machine disclosed in U.S. patent application Ser. No. 09/502,666 entitled “Currency Handling Machine Having Multiple Output Receptacles” filed on Feb. 11, 2000 or the currency scanning and counting machine 10 illustrated in FIG. 2i of U.S. Pat. No. 5,992,601. Furthermore, while the ensuing discussion entails the scanning of currency bills, the system of the present invention is applicable to other documents as well. For example, the system of the present invention may be employed in conjunction with other documents such as stock certificates, bonds, and postage and food stamps. One embodiment of the currency handling system of FIG. 1 is designed to transport and process bills at a rate in excess of 800 bills per minute. In an alternative embodiment, the currency handling system of FIG. 1 is designed to transport and process bills at a rate in excess of 1000 bills per minute. In another alternative embodiment, the currency handling system of FIG. 1 is designed to transport and process bills at a rate in excess of 1200 bills per minute. In still another alternative embodiment, the currency handling system of FIG. 1 is designed to transport and process bills at a rate in excess of 1500 bills per minute.

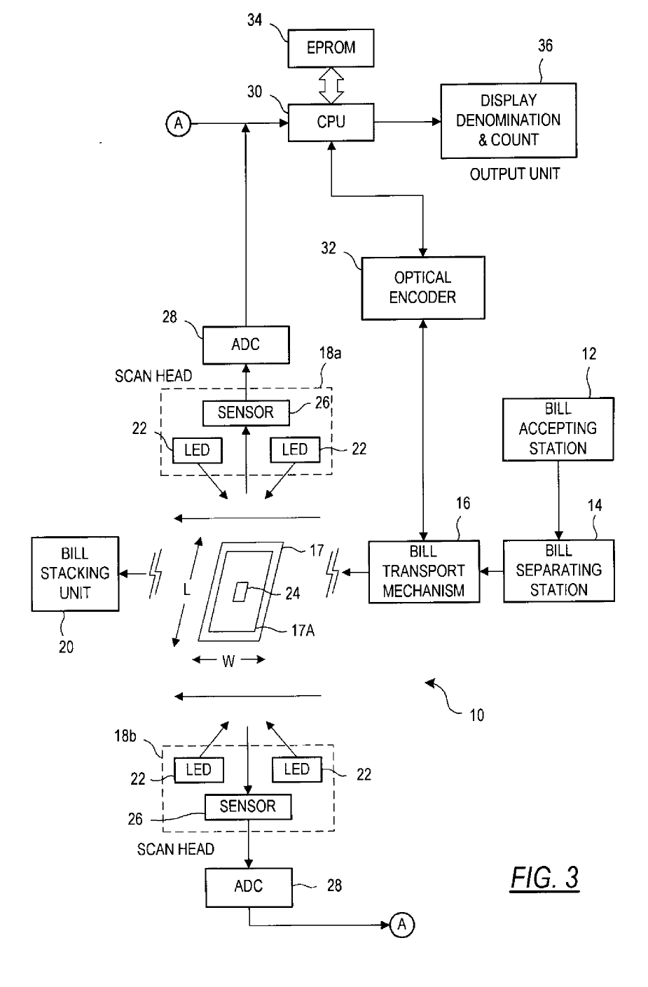

Referring now to FIGS. 2 and 3, there are shown a functional block diagrams illustrating currency discriminating systems having one and two scanheads, respectively. The systems 10 includes a bill accepting station 12 where stacks of currency bills that need to be identified and counted are positioned. Accepted bills are acted upon by a bill separating station 14 which functions to pick out or separate one bill at a time for being sequentially relayed by a bill transport mechanism 16, according to a precisely predetermined transport path, across scanhead 18 (FIG. 2) or scanheads 18a and 18b (FIG. 3) where the currency denomination of the bill is scanned and identified. Scanhead 18 is an optical scanhead that scans for characteristic information from a scanned bill 17 which is used to identify the denomination of the bill. Likewise for scanheads 18a and 18b. The scanned bill 17 is then transported to a bill stacking station 20 where bills so processed are stacked for subsequent removal.

The optical scanheads (18 of FIG. 2; 18a,b of FIG. 3) comprise at least one light source 22 directing a beam of light downwardly onto the bill transport path so as to illuminate a substantially rectangular light strip 24 upon a currency bill 17 positioned on the transport path below the scanhead 18 and between the scanheads 18a and 18b. Light reflected off the illuminated strip 24 is sensed by a photodetector 26 positioned directly above the strip. The analog output of photodetector 26 is converted into a digital signal by means of an analog-to-digital (ADC) convertor unit 28 whose output is fed as a digital input to a central processing unit (CPU) 30.

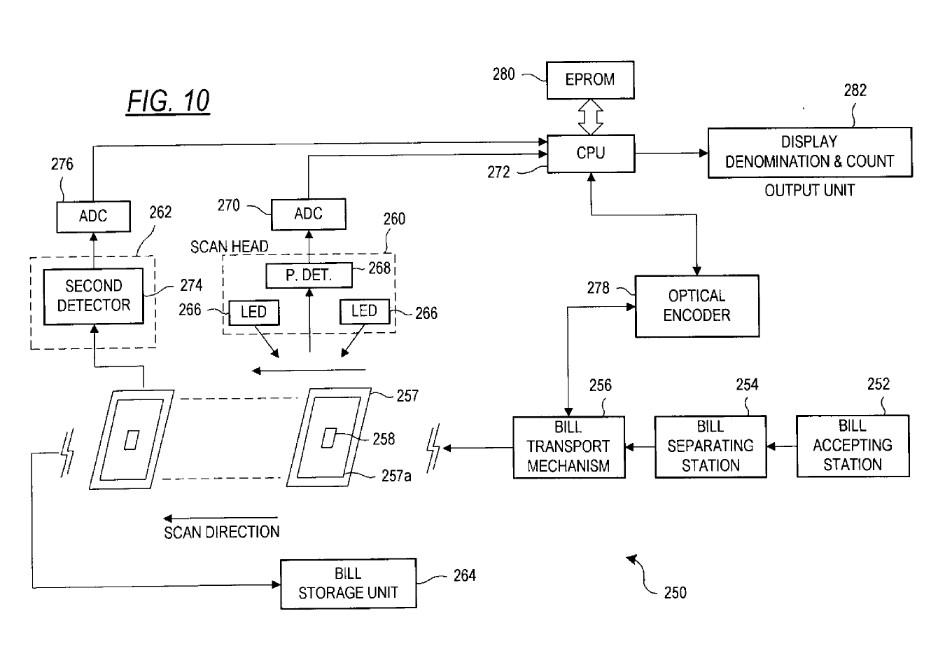

While scanheads 18, 18a, and 18b are optical scanheads, it should be understood that they may be designed to detect a variety of characteristic information from currency bills. Additionally, the scanheads may employ a variety of detection means such as magnetic, optical, electrical conductivity, and capacitive sensors. Use of such sensors is discussed in more detail below, for example, in connection with FIG. 10. For example, the scanheads may employ a magnetoresistive sensor or a plurality of such sensors including an array of such sensors. Such a sensor or sensors may, for example, be used to detect magnetic flux.

Referring again to FIG. 2 and FIG. 3, the bill transport path is defined in such a way that the transport mechanism 16 moves currency bills with the narrow dimension of the bills being parallel to the transport path and the scan direction. Alternatively, the system 10 may be designed to scan bills along their long dimension or along a skewed dimension. As a bill 17 moves on the transport path past the scanhead(s), the light strip 24 effectively scans the bill across the narrow dimension of the bill. As depicted, the transport path is so arranged that a currency bill 17 is scanned by the scanhead(s) approximately about the central section of the bill along its narrow dimension, as shown in FIGS. 2 and 3. The scanheads function to detect light reflected from the bill as it moves across the illuminated light strip 24 and to provide an analog representation of the variation in light so reflected which, in turn, represents the variation in the dark and light content of the printed pattern or indicia on the surface of the bill. This variation in light reflected from the narrow dimension scanning of the bills serves as a measure for distinguishing, with a high degree of confidence, among a plurality of currency denominations which the system of this invention is programmed to handle.

A series of such detected reflectance signals are obtained across the narrow dimension of the bill, or across a selected segment thereof, and the resulting analog signals are digitized under control of the CPU 30 to yield a fixed number of digital reflectance data samples. The data samples are then subjected to a digitizing process which includes a normalizing routine for processing the sampled data for improved correlation and for smoothing out variations due to contrast fluctuations in the printed pattern existing on the bill surface. The normalized reflectance data so digitized represents a characteristic pattern that is fairly unique for a given bill denomination and provides sufficient distinguishing features among characteristic patterns for different currency denominations. This process is more fully explained in commonly owned U.S. Pat. No. 5,295,196 for a “Method and Apparatus for Currency Discrimination and Counting” filed on May 19, 1992 which is incorporated herein by reference in its entirety.

In order to ensure strict correspondence between reflectance samples obtained by narrow dimension scanning of successive bills, the initiation of the reflectance sampling process is preferably controlled through the CPU 30 by means of an encoder 32 which is linked to the bill transport mechanism 16 and precisely tracks the physical movement of the bill 17 across the scanhead(s). In one embodiment of the present inventions, the encoder 32 is an optical encoder. More specifically, the encoder 32 is linked to the rotary motion of the drive motor which generates the movement imparted to the bill as it is relayed along the transport path. In addition, the mechanics of the feed mechanism (not shown, see U.S. Pat. No. 5,295,196 referred to above) ensure that positive contact is maintained between the bill and the transport path, particularly when the bill is being scanned by the scanhead(s). Under these conditions, the encoder 32 is capable of precisely tracking the movement of the bill 17 relative to the light strip 24 generated by the scanhead(s) by monitoring the rotary motion of the drive motor.

The output of photodetector 26 is monitored by the CPU 30 to initially detect the presence of the bill underneath the scanhead 18 and between the scanheads 18a and 18b and, subsequently, to detect the starting point of the printed pattern on the bill, as represented by the thin borderline 17a which typically encloses the printed indicia on currency bills. Once the borderline 17a has been detected, the encoder 32 is used to control the timing and number of reflectance samples that are obtained from the output of the photodetector 26 as the bill 17 moves across the scanhead(s) and is scanned along its narrow dimension.

The use of the encoder 32 for controlling the sampling process relative to the physical movement of a bill 17 across the scanhead(s) is also advantageous in that the encoder 32 can be used to provide a predetermined delay following detection of the borderline prior to initiation of samples. The encoder delay can be adjusted in such a way that the bill 17 is scanned only across those segments along its narrow dimension which contain the most distinguishable printed indicia relative to the different currency denominations.

In the case of U.S. currency, for instance, it has been determined that the central, approximately two-inch (approximately 5 cm) portion of currency bills, as scanned across the central section of the narrow dimension of the bill, provides sufficient data for distinguishing among the various U.S. currency denominations on the basis of the correlation technique disclosed in U.S. Pat. No. 5,295,196 referred to above. Accordingly, the encoder 32 can be used to control the scanning process so that reflectance samples are taken for a set period of time and only after a certain period of time has elapsed since the borderline 17A has been detected, thereby restricting the scanning to the desired central portion of the narrow dimension of the bill.

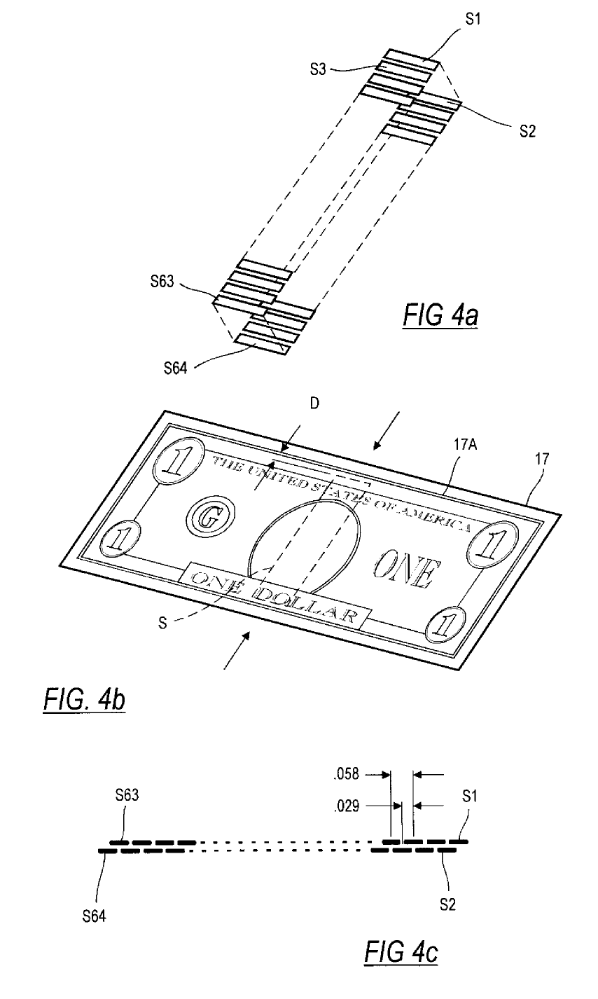

FIGS. 4a-4c illustrate the scanning process of scanheads in more detail. Referring to FIG. 4b, as a bill 17 is advanced in a direction parallel to the narrow edges of the bill, scanning via a wide slit in the scanhead(s) is effected along a segment S of the central portion of the bill 17. This segment S begins a fixed distance D inboard of the borderline 17a. As the bill 17 traverses the scanhead(s), a strip s of the segment S is always illuminated, and the photodetector 26 produces a continuous output signal which is proportional to the intensity of the light reflected from the illuminated strip s at any given instant. This output is sampled at intervals controlled by the encoder, so that the sampling intervals are precisely synchronized with the movement of the bill across the scanhead(s).

As illustrated in FIGS. 4a and 4c, it is preferred that the sampling intervals be selected so that the strips s that are illuminated for successive samples overlap one another. The odd-numbered and even-numbered sample strips have been separated in FIGS. 4a and 4c to more clearly illustrate this overlap. For example, the first and second strips s1 and s2 overlap each other, the second and third strips s2 and s3 overlap each other, and so on. Each adjacent pair of strips overlap each other. For U.S. currency, this is accomplished by sampling strips that are 0.050 inch (0.127 cm) wide at 0.029 inch (0.074 cm) intervals, along a segment S that is 1.83 inch (4.65 cm) long (64 samples).

The optical sensing and correlation technique is based upon using the above process to generate a series of stored intensity signal patterns using genuine bills for each denomination of currency that is to be detected. According to one embodiment, two or four sets of master intensity signal samples are generated and stored within system memory, preferably in the form of an EPROM 34 (see FIGS. 2 and 3), for each detectable currency denomination. The sets of master intensity signal samples for each bill are generated from optical scans, performed on the green surface of the bill and taken along both the “forward” and “reverse” directions relative to the pattern printed on the bill. Alternatively, the optical scanning may be performed on the black side of U.S. currency bills or on either surface of bills from other countries. Additionally, the optical scanning may be performed on both sides of a bill, for example, by placing a scanhead on each side of the bill transport path as described in more detail in commonly owned U.S. Pat. No. 5,467,406 entitled “Method and Apparatus for Currency Discrimination” filed on Mar. 8, 1994 and incorporated herein by reference in its entirety.

In adapting this technique to U.S. currency, for example, sets of stored intensity signal samples are generated and stored for seven different denominations of U.S. currency, i.e., $1, $2, $5, $10, $20, $50 and $100. For bills which produce significant pattern changes when shifted slightly to the left or right, such as the $2 and the $10 bill in U.S. currency, it is preferred to store two patterns for each of the “forward” and “reverse” directions, each pair of patterns for the same direction represent two scan areas that are slightly displaced from each other along the long dimension of the bill. Accordingly, a set of a number of different master characteristic patterns is stored within the system memory for subsequent correlation purposes. Once the master patterns have been stored, the pattern generated by scanning a bill under test is compared by the CPU 30 with each of the master patterns of stored intensity signal samples to generate, for each comparison, a correlation number representing the extent of correlation, i.e., similarity between corresponding ones of the plurality of data samples, for the sets of data being compared.

The CPU 30 is programmed to identify the denomination of the scanned bill as corresponding to the set of stored intensity signal samples for which the correlation number resulting from pattern comparison is found to be the highest. In order to preclude the possibility of mischaracterizing the denomination of a scanned bill, as well as to reduce the possibility of spurious notes being identified as belonging to a valid denomination, a bi-level threshold of correlation is used as the basis for making a “positive” call. Such a method is disclosed in U.S. Pat. No. 5,295,196 referred to above. If a “positive” call can not be made for a scanned bill, an error signal is generated.

Using the above sensing and correlation approach, the CPU 30 is programmed to count the number of bills belonging to a particular currency denomination as part of a given set of bills that have been scanned for a given scan batch, and to determine the aggregate total of the currency amount represented by the bills scanned during a scan batch. The CPU 30 is also linked to an output unit 36 (FIG. 1b and 1c) which is adapted to provide a display of the number of bills counted, the breakdown of the bills in terms of currency denomination, and the aggregate total of the currency value represented by counted bills. The output unit 36 can also be adapted to provide a print-out of the displayed information in a desired format.

A procedure for scanning bills and generating characteristic patterns is described in U.S. Pat. No. 5,295,196 referred to above and incorporated by reference in its entirety and in commonly owned U.S. Pat. No. 5,633,949 entitled “Method and Apparatus for Currency Discrimination” filed on May 16, 1994.

The optical sensing and correlation technique described in U.S. Pat. No. 5,295,196 permits identification of pre-programmed currency denominations with a high degree of accuracy and is based upon a relatively short processing time for digitizing sampled reflectance values and comparing them to the master characteristic patterns. The approach is used to scan currency bills, normalize the scanned data and generate master patterns in such a way that bill scans during operation have a direct correspondence between compared sample points in portions of the bills which possess the most distinguishable printed indicia. A relatively low number of reflectance samples is required in order to be able to adequately distinguish among several currency denominations.

The system can conveniently be programmed to set a flag when a scanned pattern does not correspond to any of the master patterns. The identification of such a condition can be used to stop the bill transport drive motor for the mechanism. Since the encoder is tied to the rotational movement of the drive motor, synchronism can be maintained between pre- and post-stop conditions. Additionally, a bill meeting or failing to meet some other criteria, such as being identified to be a suspect bill, may be flagged in a similar manner by stopping the transport mechanism.

The mechanical portions and the operation of a currency discrimination and counting machine such as that of FIGS. 1, 2, and 3 are described in detail in commonly owned U.S. Pat. No. 5,992,601 entitled “Method and Apparatus for Document Identification and Authentication” filed on Feb. 14, 1997 which incorporated herein by reference in its entirety. One scanhead or a plurality of scanheads may be used in various alternative embodiment of the present invention. The physical arrangement of the scanhead(s) may also vary according to various alternative embodiments of the present invention. For example, the scanheads may be aligned along the same lateral axis.

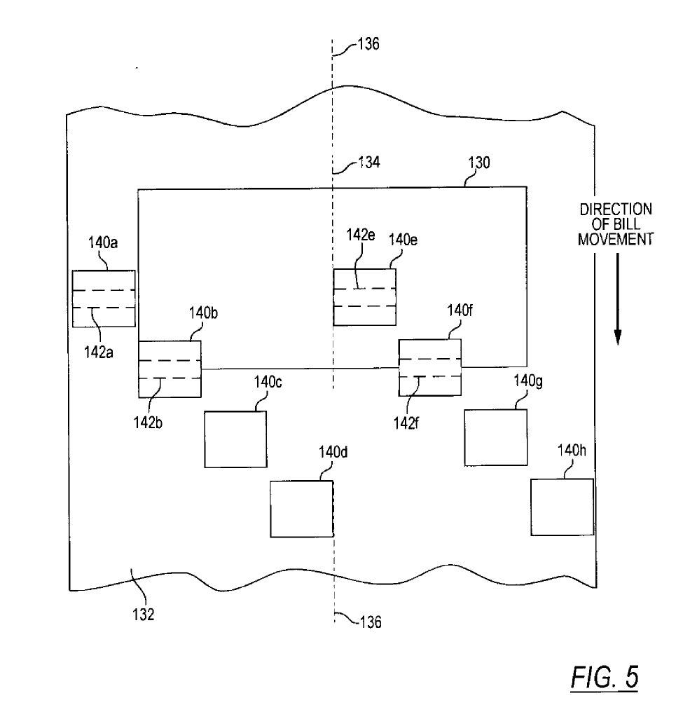

Referring now to FIG. 5, alternatively, the scanheads may be, for example, staggered upstream and downstream from each other. FIG. 5 is a top view of a staggered scanhead arrangement according to one embodiment of the present invention. As illustrated in FIG. 5, a bill 130 is transported in a centered manner along the transport path 132 so that the center 134 of the bill 130 is aligned with the center 136 of the transport path 132. Scanheads 140a-h are arranged in a staggered manner so as to permit scanning of the entire width of the transport path 132. The areas illuminated by each scanhead are illustrated by strips 142a, 142b, 142e, and 142f for scanheads 140a, 140b, 140e, and 140f, respectively. Based on size determination sensors, scanheads 140a and 140h may either not be activated or their output ignored. While the scanheads 140a-h of FIG. 5 are arranged in a non-overlapping manner, they may alternatively be arranged in an overlapping manner. By providing additional lateral positions, an overlapping scanhead arrangement may provide greater selectivity in the segments to be scanned. This increase in scannable segments may be beneficial in compensating for currency manufacturing tolerances which result in positional variances of the printed indicia on bills relative to their edges. Additionally, in one embodiment, scanheads positioned above the transport path are positioned upstream relative to their corresponding scanheads positioned below the transport path. In addition to size and scanned characteristic patterns, color may also be used to discriminate bills. For example, while all U.S. bills are printed in the same colors, e.g., a green side and a black side, bills from other countries often vary in color with the denomination of the bill. For example, a German 50 deutsche mark bill-type is brown in color while a German 100 deutsche mark bill-type is blue in color. Alternatively, color detection may be used to determine the face orientation of a bill, such as where the color of each side of a bill varies. For example, color detection may be used to determine the face orientation of U.S. bills by detecting whether or not the “green” side of a U.S. bill is facing upwards. Separate color sensors may be added upstream of the scanheads described above. According to such an embodiment, color information may be used in addition to size information to preliminarily identify a bill. Likewise, color information may be used to determine the face orientation of a bill which determination may be used to select upper or lower scanheads for scanning a bill accordingly or compare scanned patterns retrieved from upper scanheads with a set of master patterns generated by scanning a corresponding face while the scanned patterns retrieved from the lower scanheads are compared with a set of master patterns generated by scanning an opposing face. Alternatively, color sensing may be incorporated into the scanheads described above. Such color sensing may be achieved by, for example, incorporating color filters, colored light sources, and/or dichroic beamsplitters into the currency discrimination system of the present invention. Various color information acquisition techniques are described in U.S. Pat. Nos. 4,841,358; 4,658,289; 4,716,456; 4,825,246; and 4,992,860.

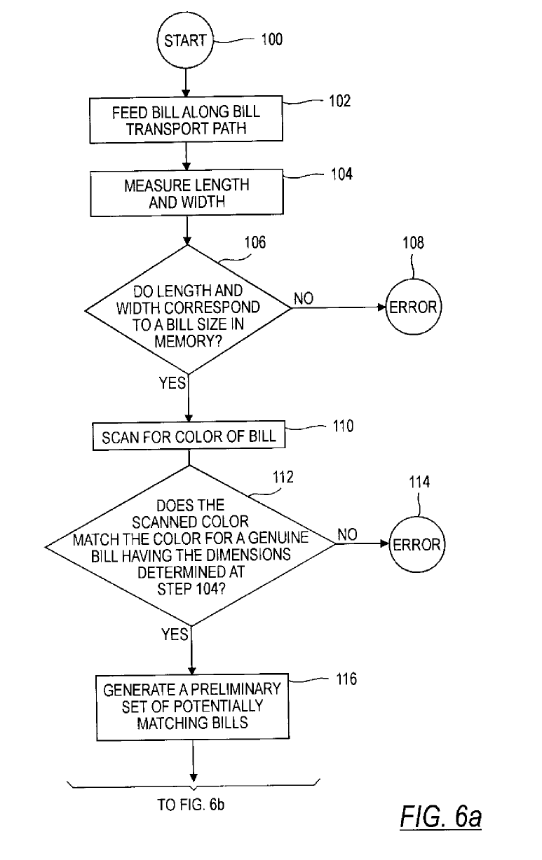

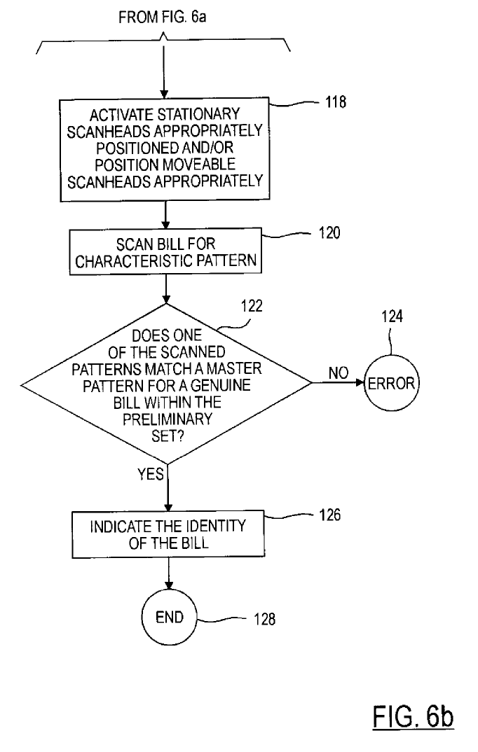

The operation of a currency discriminator according to one embodiment of the present invention may be further understood by referring to the flowchart of FIGS. 6a and 6b. In the process beginning at step 100, a bill is fed along a transport path (step 102) past sensors which measure the length and width of the bill (step 104). Next at step 106, it is determined whether the measured dimensions of the bill match the dimensions of at least one bill stored in memory, such as EPROM 34 of FIGS. 2-3. If no match is found, an appropriate error is generated at step 108. If a match is found, the color of the bill is scanned for at step 10. At step 112, it is determined whether the color of the bill matches a color associated with a genuine bill having the dimensions measured at step 104. An error is generated at step 114 if no such match is found. However, if a match is found, a preliminary set of potentially matching bills is generated at step 116. Often, only one possible identity will exist for a bill having a given color and dimensions. However, the preliminary set of step 116 is not limited to the identification of a single bill-type, that is, a specific denomination of a specific currency system; but rather, the preliminary set may comprise a number of potential bill-types. For example, all U.S. bills have the same size and color. Therefore, the preliminary set generated by scanning a U.S. $5 bill would include U.S. bills of all denominations.

Based on the preliminary set (step 116), selected scanheads in a stationary scanhead system may be activated (step 118). For example, if the preliminary identification indicates that a bill being scanned has the color and dimensions of a German 100 deutsche mark, the scanheads over regions associated with the scanning of an appropriate segment for a German 100 deutsche mark may be activated. Then upon detection of the leading edge of the bill by sensors 68 of FIG. 4, the appropriate segment may be scanned. Alternatively, all scanheads may be active with only the scanning information from selected scanheads being processed. Alternatively, based on the preliminary identification of a bill (step 116), moveable scanheads may be appropriately positioned (step 118).

Subsequently, the bill is scanned for a characteristic pattern (step 120). At step 122, the scanned patterns produced by the scanheads are compared with the stored master patterns associated with genuine bills as dictated by the preliminary set. By only making comparisons with master patterns of bills within the preliminary set, processing time may be reduced. Thus for example, if the preliminary set indicated that the scanned bill could only possibly be a German 100 deutsche mark, then only the master pattern or patterns associated with a German 100 deutsche mark need be compared to the scanned patterns. If no match is found, an appropriate error is generated (step 124). If a scanned pattern does match an appropriate master pattern, the identity of the bill is accordingly indicated (step 126) and the process is ended (step 128).

While some of the embodiments discussed above entailed a system capable of identifying a plurality of bill-types, the system may be adapted to identify a bill under test as either belonging to a specific bill-type or not. For example, the system may be adapted to store master information associated with only a single bill-type such as a United Kingdom 5 pound bill. Such a system would identify bills under test which were United Kingdom 5 pound bills and would reject all other bill-types.

The scanheads of the present invention may be incorporated into a document identification system capable of identifying a variety of documents. For example, the system may be designed to accommodate a number of currencies from different countries. Such a system may be designed to permit operation in a number of modes. For example, the system may be designed to permit an operator to select one or more of a plurality of bill-types which the system is designed to accommodate. Such a selection may be used to limit the number of master patterns with which scanned patterns are to be compared. Likewise, the operator may be permitted to select the manner in which bills will be fed, such as all bills face up, all bills top edge first, random face orientation, and/or random top edge orientation. Additionally, the system may be designed to permit output information to be displayed in a variety of formats to a variety of peripherals, such as a monitor, LCD display, or printer. For example, the system may be designed to count the number of each specific bill-types identified and to tabulate the total amount of currency counted for each of a plurality of currency systems. For example, a stack of bills could be placed in the bill accepting station 12 of FIGS. 2-3, and the output unit 36 of FIGS. 2-3 may indicate that a total of 370 British pounds and 650 German marks were counted. Alternatively, the output from scanning the same batch of bills may provide more detailed information about the specific denominations counted, for example one 100 pound bill, five 50 pound bills, and one 20 pound bill and thirteen 50 deutsche mark bills.

Alternatively to employing optical scanheads as described above, a magnetic sensor or sensors may be employed such as the Gradiometer available from NVE Nonvolatile Electronics, Inc., Eden Praire, Minn. For example, a magnetoresistive sensor may be employed to detect, for example, magnetic flux. Examples of magnetoresistive sensors are described in, for example, U.S. Pat. Nos. 5,119,025, 4,683,508, 4,413,296, 4,388,662, and 4,164,770. Additionally, other types of magnetic sensors may be employed for detecting magnetic flux such as Hall effect sensors and flux gates.

A variety of currency characteristics can be measured using magnetic sensing. These include detection of patterns of changes in magnetic flux (U.S. Pat. No. 3,280,974), patterns of vertical grid lines in the portrait area of bills (U.S. Pat. No. 3,870,629), the presence of a security thread (U.S. Pat. No. 5,151,607), total amount of magnetizable material of a bill (U.S. Pat. No. 4,617,458), patterns from sensing the strength of magnetic fields along a bill (U.S. Pat. No. 4,593,184), and other patterns and counts from scanning different portions of the bill such as the area in which the denomination is written out (U.S. Pat. No. 4,356,473). An additional type of magnetic detection system is described in U.S. Pat. No. 5,418,458.

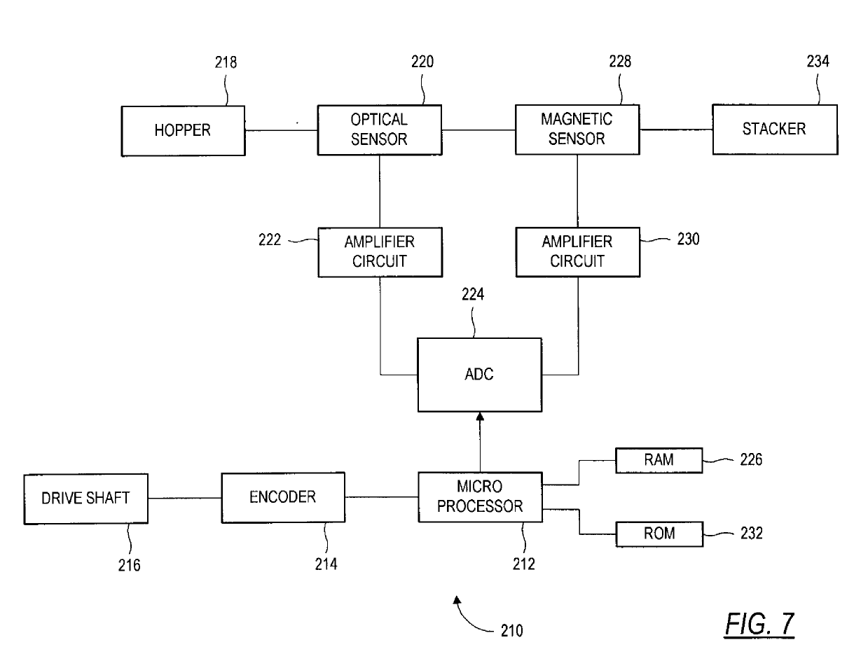

FIG. 7 shows a block diagram of a counterfeit detector 210. A microprocessor 212 controls the overall operation of the counterfeit detector 210. It should be noted that the detailed construction of a mechanism to convey bills through the counterfeit detector 210 is not related to the practice of the present invention. Many configurations are well-known in the prior art. An exemplary configuration includes an arrangement of pulleys and rubber belts driven by a single motor. An encoder 214 may be used to provide input to the microprocessor 212 based on the position of a drive shaft 216, which operates the bill-conveying mechanism. The input from the encoder 214 allows the microprocessor to calculate the position of a bill as it travels and to determine the timing of the operations of the counterfeit detector 210.

A stack of currency (not shown) may be deposited in a hopper 218 which holds the currency securely and allows the bills in the stack to be conveyed one at a time through the counterfeit detector 210. After the bills are conveyed to the interior of the counterfeit detector 210, a portion of the bill is optically scanned by an optical sensor 220 of the type commonly known in the art. The optical sensor generates signals that correspond to the amount of light reflected by a small portion of the bill. Signals from the optical sensor 220 are sent to an amplifier circuit 222, which, in turn, sends an output to an analog-to-digital convertor 224. The output of the ADC is read by the microprocessor 212. The microprocessor 212 stores each element of data from the optical sensor 220 in a range of memory locations in a random access memory (“RAM”) 226, forming a set of image data that corresponds to the object scanned.

As the bill continues its travel through the counterfeit detector 210, it is passed adjacent to a magnetic sensor 228, which detects the presence of magnetic ink. The magnetic sensor 228 desirably makes a plurality of measurements along a path parallel to one edge of the bill being examined. For example, the path sensed by the magnetic sensor 228 may be parallel to the shorter edges of the bill and substantially through the bill's center. The output signal from the magnetic sensor 228 is amplified by an amplifier circuit 230 and digitized by the ADC 224. The digital value of each data point measured by the magnetic sensor 228 is read by the microprocessor 212, whereupon it is stored in a range of memory in the RAM 226. The digitized magnetic data may be mathematically manipulated to simplify its use. For example, the value of all data points may be summed to yield a checksum, which may be used for subsequent comparison to expected values computed from samples of genuine bills. As will be apparent, calculation of a checksum for later comparison eliminates the need to account for the orientation of the bill with respect to the magnetic sensor 228. This is true because the checksum represents the concentration of magnetic ink across the entire path scanned by the magnetic sensor 228, regardless of variations caused by higher concentrations in certain regions of the bill.

The image data stored in the RAM 226 is compared by the microprocessor 212 to standard image data stored in a read only memory (“ROM”) 232. The stored image data corresponds to optical data generated from genuine currency of a plurality of denominations. The ROM image data may represent various orientations of genuine currency to account for the possibility of a bill in the stack being in a reversed orientation compared to other bills in the stack. If the image data generated by the bill being evaluated does not fall within an acceptable limit of any of the images stored in ROM, the bill is determined to be of an unknown denomination. The machine stops to allow removal of the document from the stack of currency.

If the image data from the bill being evaluated corresponds to one of the images stored in the ROM 232, the microprocessor 212 compares the checksum of the magnetic data to one of a plurality of expected checksum values stored in the ROM 232. An expected checksum value is stored for each denomination that is being counted. The value of each expected checksum is determined, for example, by averaging the magnetic data from a number of genuine samples of each denomination of interest. If the value of the measured checksum is within a predetermined range of the expected checksum, the bill is considered to be genuine. If the checksum is not within the acceptable range, the operator is signaled that the document is suspect and the operation of the counterfeit detector 210 is stopped to allow its retrieval.

If the bill passes both the optical evaluation and the magnetic evaluation, it exits the counterfeit detector 210 to a stacker 234. Furthermore, the counterfeit detector 210 may desirably include the capability to maintain a running total of genuine currency of each denomination.

It should be noted that the magnetic checksum is only compared to the expected checksum for a single denomination (i.e. the denomination that the optical data comparison has indicated). Thus, the only way in which a bill can be classified as genuine is if its magnetic checksum is within an acceptable range for its specific denomination. For a counterfeit bill to be considered genuine by the counterfeit detector of the present invention, it would have to be within an acceptable range in the denomination-discriminating optical comparison and have a distribution of magnetic ink within an acceptable range for its specific denomination.

To summarize the operation of the system, a stack of bills is fed into the hopper 218. Each bill is transported adjacent to the optical sensor 220, which generates image data corresponding to one side of the bill. The bill is also scanned by a magnetic sensor 228 and a plurality of data points corresponding to the presence of magnetic ink are recorded by the microprocessor 212. A checksum is generated by adding the total of all magnetic data points. The image data generated by the optical sensor 220 is compared to stored images that correspond to a plurality of denominations of currency. When the denomination of the bill being evaluated has been determined, the checksum is compared to a stored checksum corresponding to a genuine bill of that denomination. The microprocessor 212 generates a signal indicating that the bill is genuine or counterfeit depending on whether said data is within a predetermined range of the expected value. Bills exit the counterfeit detector 210 and are accumulated in the stacker 234.

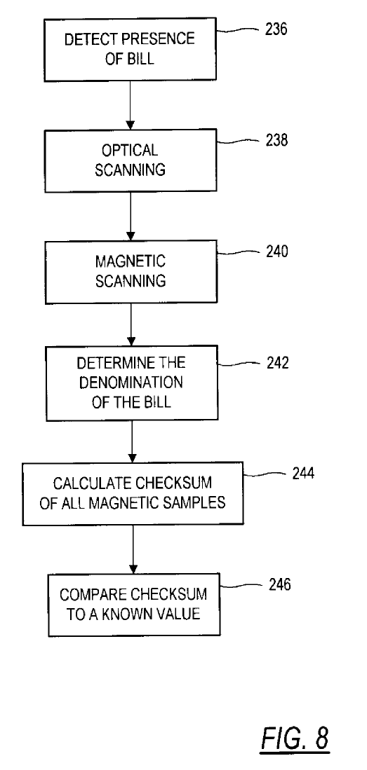

FIG. 8 is a flow diagram of an exemplary system according to an embodiment of the present invention. At step 236, the presence of a bill approaching the optical sensor 220 is detected by the microprocessor 212, which initiates an optical scanning operation 238. Image data generated by the optical scanning operation are stored in RAM 226. The number of optical samples taken is not critical to the operation of the present invention, but the probability of accurate classification of the denomination of a bill increases as the number of samples increases.

At step 240, the microprocessor 212 initiates the magnetic scanning operation. The data points obtained by the magnetic scanning operation may be stored in the RAM 226 and added together later to yield a checksum, as shown in step 244. Alternatively, the checksum may be calculated by keeping a running total of the magnetic data values by adding each newly acquired value to the previous total. As with the optical scanning operation, the number of data points measured is not essential, but the chances of accurately identifying a counterfeit bill based on the concentration of magnetic ink improve as the number of samples increases. At step 242, the microprocessor determines the denomination of the bill by comparing the image data to a plurality of known images, each of which corresponds to a specific denomination of currency. The bill is identified as belonging to the denomination corresponding to one of the known scan patterns if the correlation between the two is within an acceptable range. At step 246, the checksum resulting from the summation of the magnetic data points is compared to an expected value for a genuine bill of the denomination identified by the comparison of the image data to the stored data.

The expected value may be determined in a variety of ways. One method is to empirically measure the concentration of magnetic ink on a sample of genuine bills and average the measured concentrations. Another method is to program the microprocessor to periodically update the expected value based on magnetic data measurements of bills evaluated by the counterfeit detector over a period of time.

If the checksum of the bill being evaluated is within a predetermined range of the expected value, the bill is considered to be genuine. Otherwise, the bill is considered to be counterfeit. As will be apparent, the choice of an acceptable variation from the expected checksum determines the sensitivity of the counterfeit detector. If the range chosen is too narrow, the possibility that a genuine bill will be classified as counterfeit is increased. On the other hand, the possibility that a counterfeit bill will be classified as genuine increases if the acceptable range is too broad.

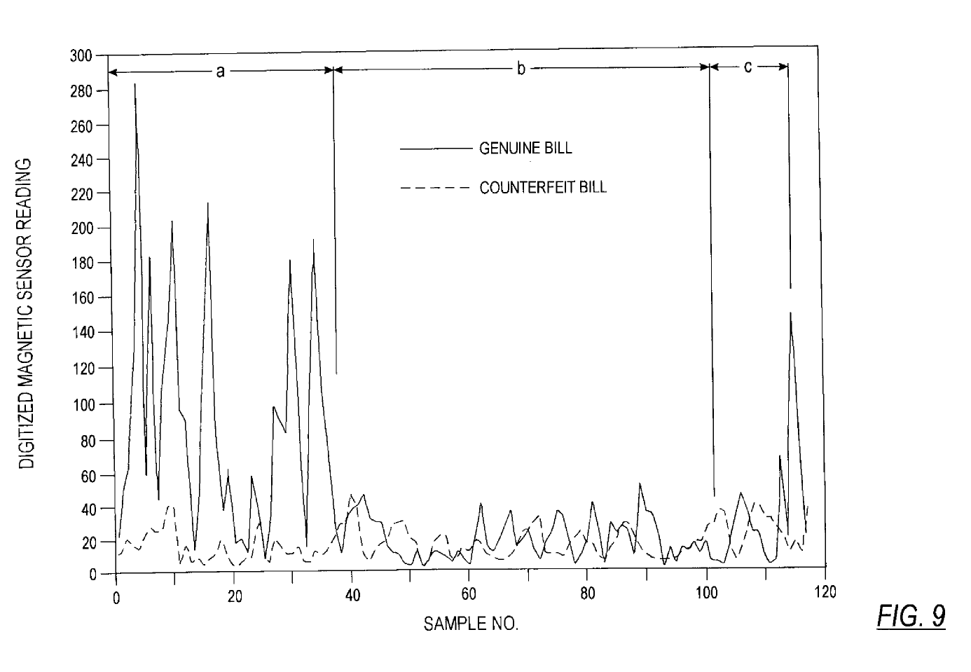

FIG. 9 is a graphical representation of the magnetic data points generated by both a genuine pre-1996 series one hundred dollar bill (solid line) and a counterfeit one hundred dollar bill (broken line). As previously noted, bills are desirably scanned along a path that is parallel to one of their short edges. The graph shown in FIG. 14 shows magnetic data obtained by scanning a path passing approximately through the center of the bill. The measurements in the region designated “a” correspond to the area at the top of the bill. The area designated “b” corresponds to the central region of the bill and the region designated “c” corresponds to the bottom of the bill. The magnetic measurements for the genuine bill are relatively high in region a because of the high concentration of magnetic ink near the top of the bill. The concentration of magnetic ink in region b is relatively small and the concentration in region c is generally between the concentrations in regions a and c.

It should be noted that the concentration of magnetic ink in a typical counterfeit bill is uniformly low. Thus, the sum of the all data points for a counterfeit bill is generally significantly lower than for a genuine bill. Nonetheless, as counterfeiting techniques become more sophisticated, the correlation between genuine bills and counterfeits has improved.

The system described above increases the chances of identifying a counterfeit bill because the denomination of a bill being evaluated is determined prior to the evaluation of the bill for genuineness. The checksum of the bill being evaluated is only compared to the expected checksum for a bill of that denomination. The process of identifying the denomination of the bill prior to evaluating it for genuineness minimizes the chance that a “good” counterfeit will generate a checksum indicative of a genuine bill of any denomination.

Alternatively, to the operation of the magnetic sensor described above in connection with FIGS. 7-9, the magnetic sensor 228 may be a magnetoresistive sensor or a plurality of such sensors, including an array of such sensors, as described above and below.

Referring next to FIG. 10, there is shown a functional block diagram illustrating one embodiment of a currency discriminating and authenticating system similar to that depicted in FIGS. 2 and 3 but illustrating the presence of a second detector. The currency discriminating and authenticating system 250 includes a bill accepting station 252 where stacks of currency bills that need to be identified, authenticated, and counted are positioned. Accepted bills are acted upon by a bill separating station 254 which functions to pick out or separate one bill at a time for being sequentially relayed by a bill transport mechanism 256, according to a precisely predetermined transport path, across two scanheads 260 and 262 where the currency denomination of the bill is identified and the genuineness of the bill is authenticated. In the embodiment depicted, the scanhead 260 is an optical scanhead that scans for a first type of characteristic information from a scanned bill 257 which is used to identify the bill's denomination. The second scanhead 262 scans for a second type of characteristic information from the scanned bill 257. While in the illustrated embodiment scanheads 260 and 262 are separate and distinct, it is understood that these may be incorporated into a single scanhead. For example, where the first characteristic sensed is intensity of reflected light and the second characteristic sensed is color, a single optical scanhead having a plurality of detectors, one or more without filters and one or more with colored filters, may be employed (U.S. Pat. No. 4,992,860 incorporated herein by reference). The scanned bill is then transported to a bill stacking station 264 where bills so processed are stacked for subsequent removal.

The optical scanhead 260 of the embodiment depicted in FIG. 10 comprises at least one light source 266 directing a beam of light downwardly onto the bill transport path so as to illuminate a substantially rectangular light strip 258 upon a currency bill 257 positioned on the transport path below the scanhead 260. Light reflected off the illuminated strip 258 is sensed by a photodetector 268 positioned directly above the strip. The analog output of the photodetector 268 is converted into a digital signal by means of an analog-to-digital (ADC) convertor unit 270 whose output is fed as a digital input to a central processing unit (CPU) 272.

The second scanhead 262 comprises at least one detector 274 for sensing a second type of characteristic information from a bill. The analog output of the detector 274 is converted into a digital signal by means of a second analog to digital converter 276 whose output is also fed as a digital input to the central processing unit (CPU) 272.

While scanhead 260 in the embodiment of FIG. 10 is an optical scanhead, it should be understood that the first and second scanheads 260 and 262 may be designed to detect a variety of characteristic information from currency bills. Additionally these scanheads may employ a variety of detection means such as magnetic or optical sensors.

Retrieved characteristic information can include reflected light properties such as reflected light intensity characteristics, light transmissivity properties, various magnetic properties of a bill, the presence of a security thread embedded within a bill, the color of a bill, the thickness or other dimension of a bill, etc.

For example, a variety of currency characteristics can be measured using magnetic sensing. These include detection of location of magnetic ink, detection of patterns of changes in magnetic flux (U.S. Pat. No. 3,280,974), patterns of vertical grid lines in the portrait area of bills (U.S. Pat. No. 3,870,629), the presence of a security thread (U.S. Pat. No. 5,151,607), thread location, thread metal content, thread material construction, thread magnetic characteristics, covert thread features such as coatings, bar codes, and microprinting, total amount of magnetizable material of a bill (U.S. Pat. No. 4,617,458), patterns from sensing the strength of magnetic fields along a bill (U.S. Pat. No. 4,593,184), and other patterns and counts from scanning different portions of the bill such as the area in which the denomination is written out (U.S. Pat. No. 4,356,473). Additionally, a magnetoresistive sensor or a plurality of such sensors including an array of magnetoresistive sensors may be employed to detect, for example, magnetic flux. Examples of magnetoresistive sensors are described in, for example, U.S. Pat. Nos. 5,119,025, 4,683,508, 4,413,296, 4,388,662, and 4,164,770. Another example of a magnetoresistive sensor that may be used is the Gradiometer available from NVE Nonvolatile Electronics, Inc., Eden Praire, Minn. Additionally, other types of magnetic sensors may be employed for detecting magnetic flux such as Hall effect sensors and flux gates.

With regard to optical sensing, a variety of currency characteristics can be measured such as detection of density (U.S. Pat. No. 4,381,447), color (U.S. Pat. Nos. 4,490,846; 3,496,370; 3,480,785), size including length and width, thickness (U.S. Pat. No. 4,255,651), the presence of a security thread (U.S. Pat. No. 5,151,607) and holes (U.S. Pat. No. 4,381,447), and other patterns of reflectance and transmission (U.S. Pat. Nos. 3,496,370; 3,679,314; 3,870,629; 4,179,685), the detection of security threads and characteristics of security threads such as location, color, (e.g., under normal and/or ultraviolet illumination), thread material construction, covert thread characteristics such as coating, bar codes, microprinting, etc. Color detection techniques may employ color filters, colored lamps, and/or dichroic beamsplitters (U.S. Pat. Nos. 4,841,358; 4,658,289; 4,716,456; 4,825,246, 4,992,860 and EP 325,364). Furthermore, optical sensing can be performed using ultraviolet light to detect reflected ultraviolet light and/or fluorescent light including detection of patterns of the same. Furthermore, optical sensing can be performed using infrared light including detection of patterns of the same. An optical sensing system using ultraviolet light is described in the assignee's co-pending U.S. patent application Ser. No. 08/317,349, filed Oct. 4, 1994, and incorporated herein by reference, and described below.

In addition to magnetic and optical sensing, other techniques of detecting characteristic information of currency include electrical conductivity sensing, capacitive sensing (U.S. Pat. No. 5,122,754 [watermark, security thread]; U.S. Pat. No. 3,764,899 [thickness]; U.S. Pat. No. 3,815,021 [dielectric properties]; U.S. Pat. No. 5,151,607 [security thread]), and mechanical sensing (U.S. Pat. No. 4,381,447 [limpness]; U.S. Pat. No. 4,255,651 [thickness]).

Referring again to FIG. 10, the bill transport path is defined in such a way that the transport mechanism 256 moves currency bills with the narrow dimension of the bills parallel to the transport path and the scan direction. Alternatively, the system 250 may be designed to scan bills along their long dimension or along a skewed dimension. As a bill 257 moves on the transport path on the scanhead 260, the light strip 258 effectively scans the bill across the narrow dimension of the bill. In the embodiment depicted, the transport path is so arranged that a currency bill 257 is scanned by scanhead 260 approximately about the central section of the bill along its narrow dimension, as best shown in FIG. 10. The scanhead 260 functions to detect light reflected from the bill as it moves across the illuminated light strip 258 and to provide an analog representation of the variation in light so reflected which, in turn, represents the variation in the dark and light content of the printed pattern or indicia on the surface of the bill. This variation in light reflected from the narrow dimension scanning of the bills serves as a measure for distinguishing, with a high degree of confidence, among a plurality of currency denominations which the system of this invention is programmed to handle.

A series of such detected reflectance signals are obtained across the narrow dimension of the bill, or across a selected segment thereof, and the resulting analog signals are digitized under control of the CPU 272 to yield a fixed number of digital reflectance data samples. The data samples are then subjected to a digitizing process which includes a normalizing routine for processing the sampled data for improved correlation and for smoothing out variations due to “contrast” fluctuations in the printed pattern existing on the bill surface. The normalized reflectance data so digitized represents a characteristic pattern that is fairly unique for a given bill denomination and provides sufficient distinguishing features between characteristic patterns for different currency denominations. This process is more fully explained in U.S. patent application Ser. No. 07/885,648, filed on May 19, 1992, now issued as U.S. Pat. No. 5,295,196 for “Method and Apparatus for Currency Discrimination and Counting,” which is incorporated herein by reference in its entirety.

In order to ensure strict correspondence between reflectance samples obtained by narrow dimension scanning of successive bills, the initiation of the reflectance sampling process is preferably controlled through the CPU 272 by means of an encoder, such as an optical encoder 278, which is linked to the bill transport mechanism 256 and precisely tracks the physical movement of the bill 257 across the scanheads 260 and 262. More specifically, the encoder 278 is linked to the rotary motion of the drive motor which generates the movement imparted to the bill as it is relayed along the transport path. In addition, the mechanics of the feed mechanism (not shown, see U.S. Pat. No. 5,295,196 referred to above) ensure that positive contact is maintained between the bill and the transport path, particularly when the bill is being scanned by scanheads 260 and 262. Under these conditions, the encoder 278 is capable of precisely tracking the movement of the bill 257 relative to the light strip 258 generated by the scanhead 260 by monitoring the rotary motion of the drive motor.

The output of photodetector 268 is monitored by the CPU 272 to initially detect the presence of the bill underneath the scanhead 260 and, subsequently, to detect the starting point of the printed pattern on the bill, as represented by the thin borderline 257a which typically encloses the printed indicia on currency bills. Once the borderline 257a has been detected, the encoder 278 is used to control the timing and number of reflectance samples that are obtained from the output of the photodetector 268 as the bill 257 moves across the scanhead 260 and is scanned along its narrow dimension.

The detection of the borderline 257a serves as an absolute reference point for initiation of sampling. If the edge of a bill were to be used as a reference point, relative displacement of sampling points can occur because of the random manner in which the distance from the edge to the borderline 257a varies from bill to bill due to the relatively large range of tolerances permitted during printing and cutting of currency bills. As a result, it becomes difficult to establish direct correspondence between sample points in successive bill scans and the discrimination efficiency is adversely affected. Embodiments triggering off the edge of the bill are discussed above, for example, in connection with FIGS. 5a and 5b.

The use of the encoder 278 for controlling the sampling process relative to the physical movement of a bill 257 across the scanhead 260 is also advantageous in that the encoder 278 can be used to provide a predetermined delay following detection of the borderline prior to initiation of samples. The encoder delay can be adjusted in such a way that the bill 257 is scanned only across those segments along its narrow dimension which contain the most distinguishable printed indicia relative to the different currency denominations.

As a result of the first comparison described above based on the reflected light intensity information retrieved by scanhead 260, the CPU 272 will have either determined the denomination of the scanned bill 257 or determined that the first scanned signal samples fail to sufficiently correlate with any of the sets of stored intensity signal samples in which case an error is generated. Provided that an error has not been generated as a result of this first comparison based on reflected light intensity characteristics, a second comparison is performed. This second comparison is performed based on a second type of characteristic information, such as alternate reflected light properties, similar reflected light properties at alternate locations of a bill, light transmissivity properties, various magnetic properties of a bill, the presence of a security thread embedded within a bill, the color of a bill, the thickness or other dimension of a bill, etc. The second type of characteristic information is retrieved from a scanned bill by the second scanhead 262. The scanning and processing by scanhead 262 may be controlled in a manner similar to that described above with regard to scanhead 260.

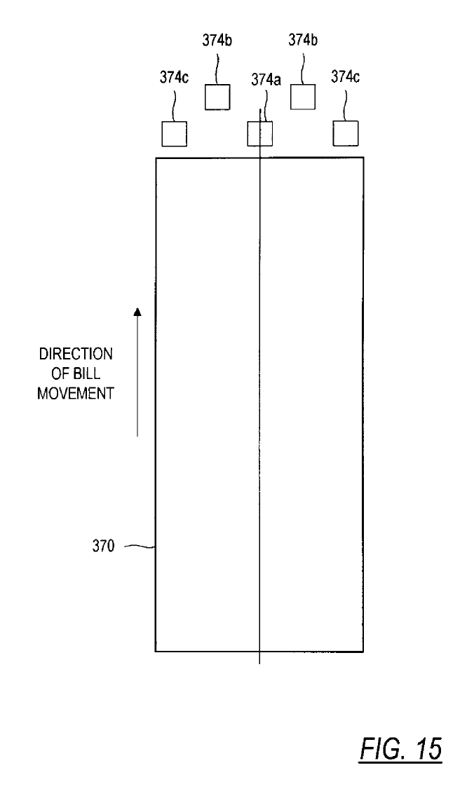

In addition to the sets of stored first characteristic information, in this example stored intensity signal samples, the EPROM 280 stores sets of stored second characteristic information for genuine bills of the different denominations which the system 250 is capable of handling. Based on the denomination indicated by the first comparison, the CPU 272 retrieves the set or sets of stored second characteristic data for a genuine bill of the denomination so indicated and compares the retrieved information with the scanned second characteristic information. If sufficient correlation exists between the retrieved information and the scanned information, the CPU 272 verifies the genuineness of the scanned bill 257. Otherwise, the CPU generates an error. While the embodiment illustrated in FIG. 15 depicts a single CPU 272 for making comparisons of first and second characteristic information and a single EPROM 280 for storing first and second characteristic information, it is understood that two or more CPUs and/or EPROMs could be used, including one CPU for making first characteristic information comparisons and a second CPU for making second characteristic information comparisons.

Using the above sensing and correlation approach, the CPU 272 is programmed to count the number of bills belonging to a particular currency denomination whose genuineness has been verified as part of a given set of bills that have been scanned for a given scan batch, and to determine the aggregate total of the currency amount represented by the bills scanned during a scan batch. The CPU 272 is also linked to an output unit 282 which is adapted to provide a display of the number of genuine bills counted, the breakdown of the bills in terms of currency denomination, and the aggregate total of the currency value represented by counted bills. The output unit 282 can also be adapted to provide a print-out of the displayed information in a desired format.

According to other embodiments of the present invention, three or more types of characteristics are retrieved from bills to be processed. These multiple types of characteristic information are used in various ways as described below to authenticate and/or denominate bills. According, the embodiment depicted in FIG. 15 may be modified to add additional sensors to detect additional characteristic information. Likewise, given sensors may be employed to detect multiple types of characteristic information. For example, an optical sensor may be employed both to generate scanned optical patterns but also to detect the presence, location, and/or color of security threads.

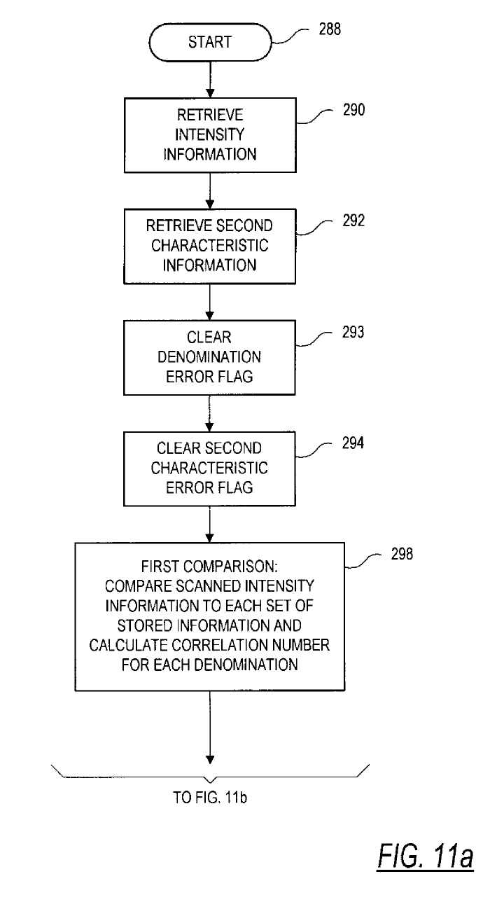

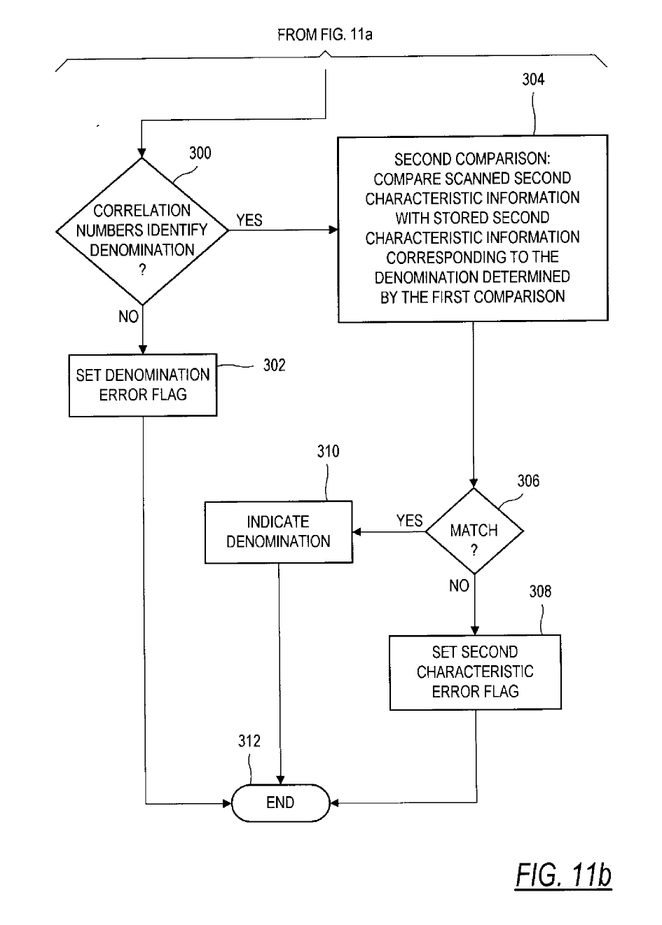

The interrelation between the use of the first and second type of characteristic information can be seen by considering FIGS. 11a and 11b which comprise a flowchart illustrating the sequence of operations involved in implementing a discrimination and authentication system according to one embodiment of the present invention. Upon the initiation of the sequence of operations (step 288), reflected light intensity information is retrieved from a bill being scanned (step 290). Similarly, second characteristic information is also retrieved from the bill being scanned (step 292). Denomination error and second characteristic error flags are cleared (steps 293 and 294). Next the scanned intensity information is compared to each set of stored intensity information corresponding to genuine bills of all denominations the system is programmed to accommodate (step 298). For each denomination, a correlation number is calculated. The system then, based on the correlation numbers calculated, determines either the denomination of the scanned bill or generates a denomination error by setting the denomination error flag (steps 300 and 302). In the case where the denomination error flag is set (step 302), the process is ended (step 312).

Alternatively, if based on this first comparison, the system is able to determine the denomination of the scanned bill, the system proceeds to compare the scanned second characteristic information with the stored second characteristic information corresponding to the denomination determined by the first comparison (step 304).

For example, if as a result of the first comparison the scanned bill is determined to be a $20 bill, the scanned second characteristic information is compared to the stored second characteristic information corresponding to a genuine $20 bill. In this manner, the system need not make comparisons with stored second characteristic information for the other denominations the system is programmed to accommodate. If based on this second comparison (step 304) it is determined that the scanned second characteristic information does not sufficiently match that of the stored second characteristic information (step 306), then a second characteristic error is generated by setting the second characteristic error flag (step 308) and the process is ended (step 312). If the second comparison results in a sufficient match between the scanned and stored second characteristic information (step 306), then the denomination of the scanned bill is indicated (step 310) and the process is ended (step 312).

TABLE 1

| | Sensitivity | | | | |
|---|---|---|---|---|---|
| Denomination | 1 | 2 | 3 | 4 | 5 |
| $1 | 200 | 250 | 300 | 375 | 450 |
| $2 | 100 | 125 | 150 | 225 | 300 |
| $5 | 200 | 250 | 300 | 350 | 400 |
| $10 | 100 | 125 | 150 | 200 | 250 |
| $20 | 120 | 150 | 180 | 270 | 360 |
| $50 | 200 | 250 | 300 | 375 | 450 |
| $100 | 100 | 125 | 150 | 250 | 350 |

An example of an interrelationship between authentication based on a first and second characteristic can be seen by considering Table 1. Table 1 depicts relative total magnetic content thresholds for various denominations of genuine bills. Columns 1-5 represent varying degrees of sensitivity selectable by a user of a device employing the present invention. The values in Table 1 are set based on the scanning of genuine bills of varying denominations for total magnetic content and setting required thresholds based on the degree of sensitivity selected. The information in Table 1 is based on the total magnetic content of a genuine $1 being 1000. The following discussion is based on a sensitivity setting of 4. In this example it is assumed that magnetic content represents the second characteristic tested. If the comparison of first characteristic information, such as reflected light intensity, from a scanned billed and stored information corresponding to genuine bills results in an indication that the scanned bill is a $10 denomination, then the total magnetic content of the scanned bill is compared to the total magnetic content threshold of a genuine $10 bill, i.e., 200. If the magnetic content of the scanned bill is less than 200, the bill is rejected. Otherwise it is accepted as a $10 bill.

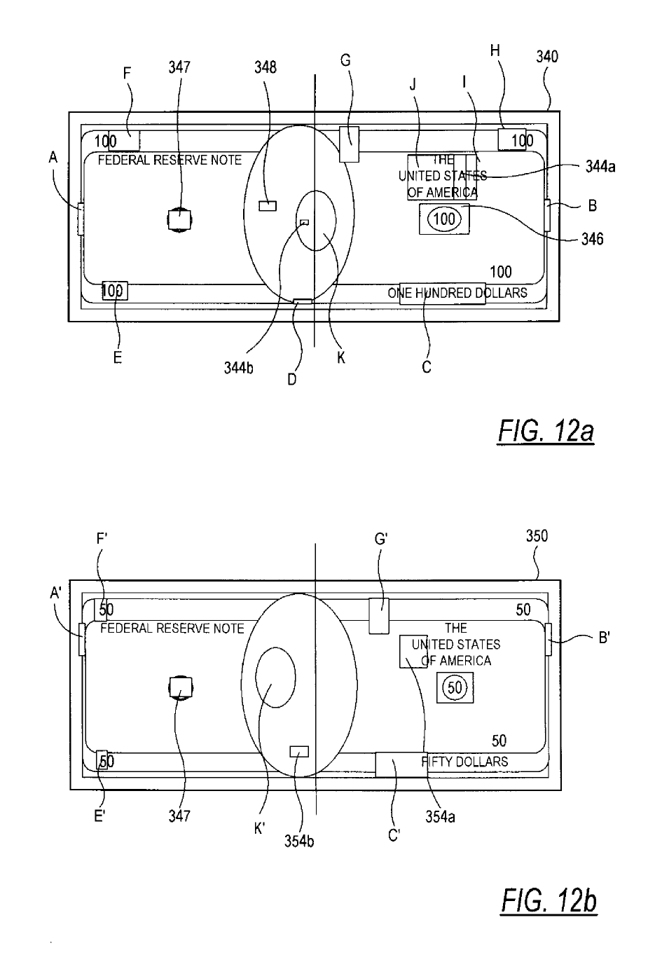

The magnetic characteristics of 1996 series $100 bills also incorporate additional security features. Referring to FIG. 12a, several areas of the bill 340 are printed using magnetic ink, such as areas A-K. Additionally, in some areas the strength of the magnetic field is stronger than it is in areas A-K. These strong areas of magnetics are indicated, for example, at 344a and 334b. Some areas, such as area 346 contain magnetic ink that is more easily detected by scanning the bill along one dimension of the bill than the other. For example, a strong magnetic field is detected by scanning over area 346 in the long or wide dimension of the bill 340 and a weak field is detected by scanning area 346 in the narrow dimension of the bill 340. The remaining areas of the bill are printed with non-magnetic ink.

Some of these magnetic characteristics vary by denomination. For example, in FIG. 12b, in a new series $50 note 350, areas A′, B′, C′, E′, F′, G′ and K′ may be printed with magnetic ink and areas 354a and 354b may exhibit even stronger magnetic characteristics. Accordingly, the non-magnetic areas also vary relative to the $100 bill. The use of magnetic ink in some areas of bills of one denomination and in other areas of bills of other denominations is referred to as magnetic zone printing. Additionally, magnetics are employed as a security feature by using ink exhibiting magnetic properties in some areas and ink that does not exhibit magnetic properties in adjacent areas wherein both the ink exhibiting and the ink not exhibiting magnetic properties appear visually the same. For example, the upper left-hand numerical 100 appears visually to be printed with the same ink. Nonetheless, the “10” are printed with ink not exhibiting magnetic properties while the last “0” is printed with ink that does exhibit magnetic properties. For example, see area F of FIG. 12a.

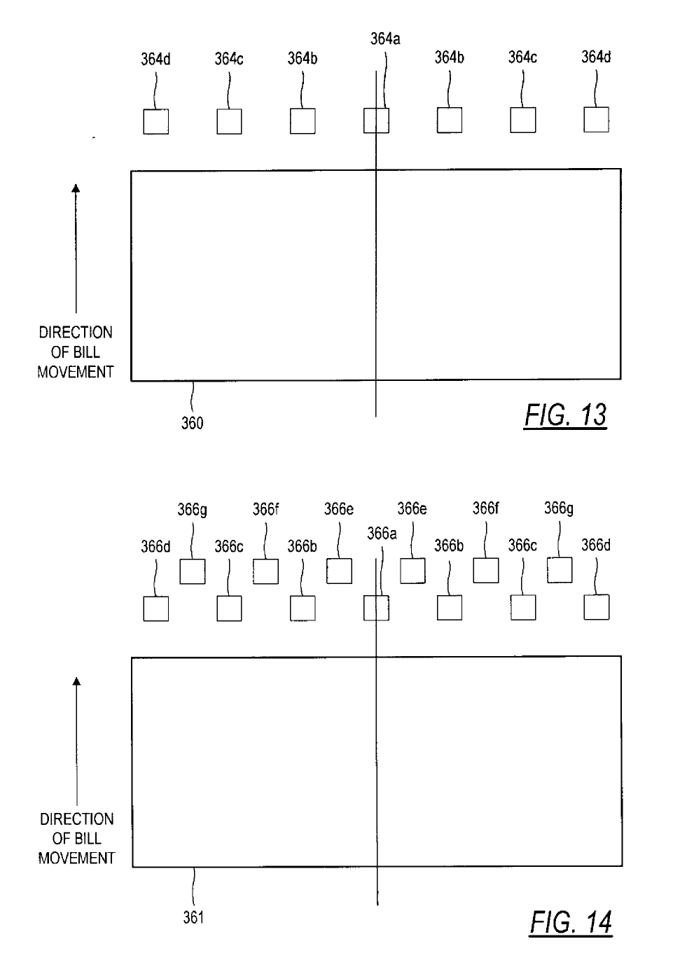

Examples of arrangements of magnetic sensors that may be used to detect the above described magnetic characteristics are illustrated in FIGS. 13, 14, and 15. FIGS. 13 and 14 illustrate bills 360 and 361 being transported past magnetic sensors 364a-d and 366a-g in the narrow dimension of the bill. FIG. 15 illustrates bill 370 being transported past magnetic sensors 374a-c in the long dimension of the bill. FIGS. 14 and 15 illustrate a staggered arrangement of sensors. Magnetic scanning using these sensors may be performed in a manner similar to that described above in connection with optical scanning. For example, each sensor may be used to generate a magnetically scanned pattern such as that depicted in FIG. 9. Such patterns may be compared to stored master magnetic patterns. The scanning may be performed in conjunction with timing signals provided by an encoder such as described above in connection with optical scanning. Sensors 364, 366, and 374 may be magnetic sensors designed to detect a variety of magnetic characteristic such as those described above. These include detection of patterns of changes in magnetic flux, total amount of magnetizable material of a bill, and patterns from sensing the strength of magnetic fields along a bill. An additional type of magnetic detection system is described in U.S. Pat. No. 5,418,458. For example, sensors 364, 366, and 374 may be magnetoresistive sensors as described above. Examples of magnetoresistive sensors are described in, for example, U.S. Pat. Nos. 5,119,025, 4,683,508, 4,413,296, 4,388,662, and 4,164,770. Another example of a magnetoresistive sensor that may be used is the Gradiometer available from NVE Nonvolatile Electronics, Inc., Eden Praire, Minn. Additionally, other types of magnetic sensors may be employed of detecting magnetic flux such as Hall effect sensors and flux gates.

Alternatively, instead of generating scanned magnetic patterns, the presence or absence of magnetic ink in various areas may be detected and compared the stored master information coinciding with several areas where magnetic ink is expected and not expected on genuine bills of various denominations. For example, the detection of magnetic ink at area F is be expected for a $100 bill but might not be for a $50 bill and vice versa for area F′. See FIGS. 12a and 12b. Accordingly, the detected magnetic information may be used to determine the denomination of a bill and/or to authenticate that a bill which has been determined to have a given denomination using a different test, such as via a comparison of an optically scanned pattern with master optical patterns, has the magnetic properties expected for that given denomination. Timing signals provided by an encoder such as described above in connection with optical scanning may be employed in detecting magnetic characteristics of specific areas of bills.

Additionally, for magnetic properties that are the same for all bills, such as the presence or absence of magnetic ink in a given location, such as the absence of magnetic ink in area 347 in FIGS. 12a and 12b, may be used as a general test to authenticate whether a given bill has the magnetic properties associated with genuine U.S. currency.

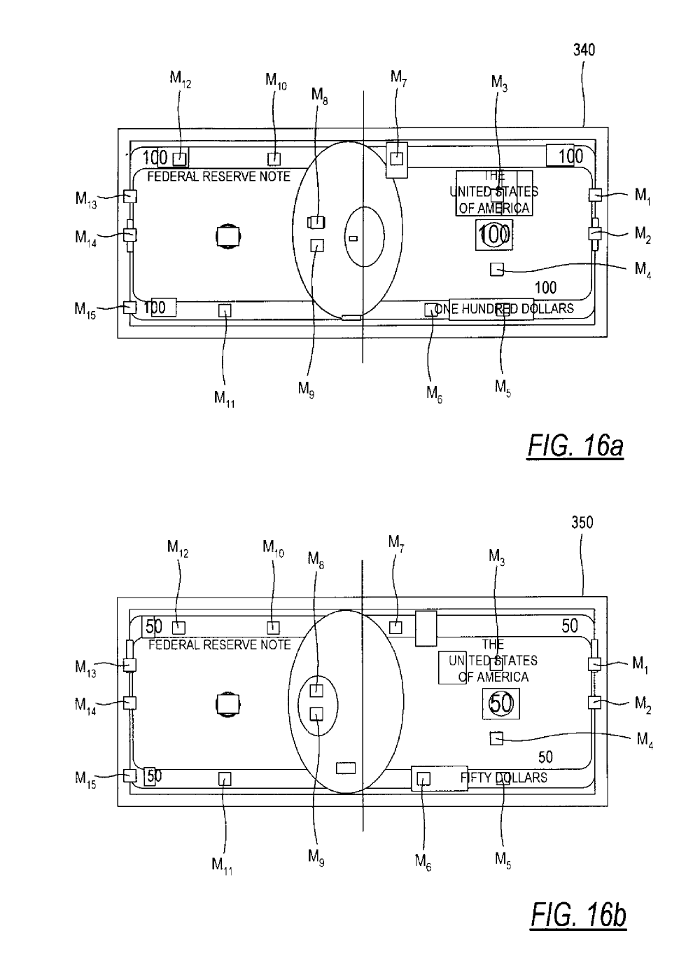

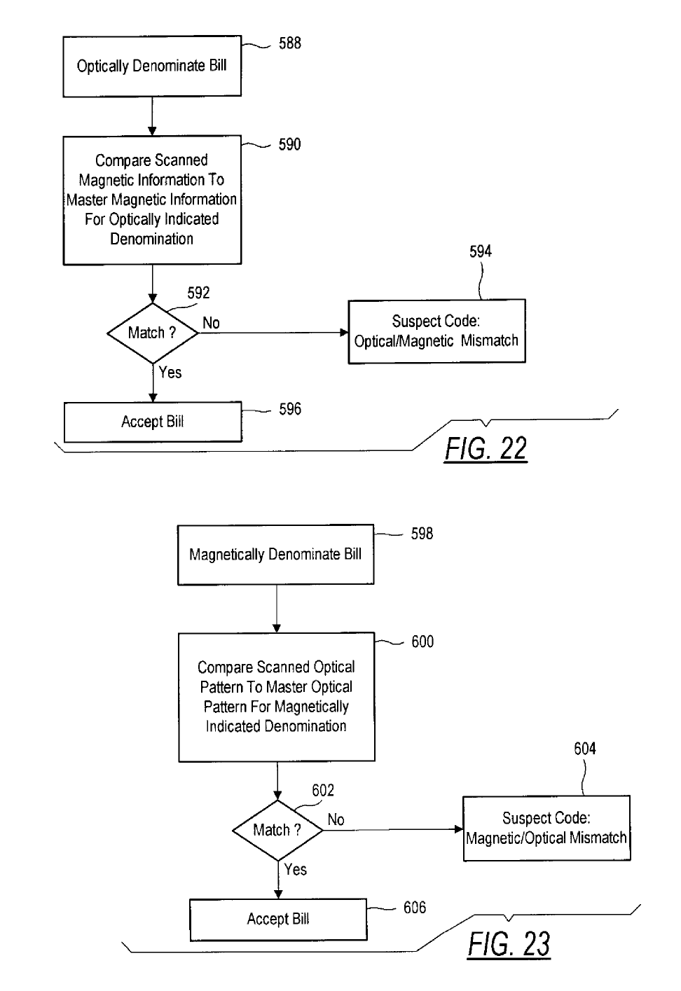

An example of scanning specific areas for the presence or absence of magnetic ink and denominating or authenticating bills based thereon may be understood with reference to FIGS. 22a and 22b. In FIGS. 16a and 16b, areas M₁-M₁₅ are scanned for the presence or absence of magnetic ink. For a 1996 series $100 bill as indicated in FIG. 16a, magnetic ink should be present at areas M₂, M₃, M₅, M₇, M₁₂, and M₁₄ but not for the other areas. For a new series $50 bill as indicated in FIG. 16b, magnetic ink might be expected at areas M₁, M₆, M₈, M₉, and M₁₃ but not for the other areas. Similarly for other denominations, magnetic ink would be expected in some areas but not others. By magnetically scanning a bill at areas M₁-M₁₅ and comparing the results with master magnetic information for each of several denominations, the denomination of the scanned billed may be determined. Alternatively, where the denomination of a bill has already be determined, the authenticity of the bill can be verified by magnetically scanning the bill at areas M₁-M₁₅ and comparing the scanned information to the master information associated with the predetermined denomination. If they sufficiently match, the bill passes the authentication test.

Alternatively, magnetic sensors 364a-d, 366a-g, and 374a-c may detect the magnitude of magnetic fields at various locations of a bill and perform bill authentication or denomination based thereon. For example, the strength of magnetic fields may be detected at areas J, 344a, and 348. See FIG. 12a. In a genuine $100 bill, no magnetic ink is present at area 348. One test to call a bill to be a $100 bill or authenticate that a bill is a $100 bill would be to compare the relative levels of magnetic field strength detected at these areas. For example, a bill may be determined genuine if a greater signal is generated by scanning area 344a than area J which in turn is greater than for area 348. Alternatively, generated signals may be compared against expected ratios, for example, that the signal for area 344a is greater than 1.5 times the signal for area J. Alternatively, the signals generated by scanning various locations may be compared to reference signals associated with genuine bills for those locations.

Another denominating or authenticating technique may be understood with reference to area 346 of FIG. 12a. It will be recalled that for this area of a $100 bill a strong magnetic signal is generated when this area is scanned in the long dimension of the bill and a weak signal is generated when this area is scanned in the narrow dimension. Accordingly, the signals generated by sensors 364 and 374 for this area can be compared to each other and/or to different threshold levels to determine whether a particular bill being scanned has these properties. This information may be then used to assist in calling the denomination of the bill or authenticating a bill whose denomination has previously been determined.

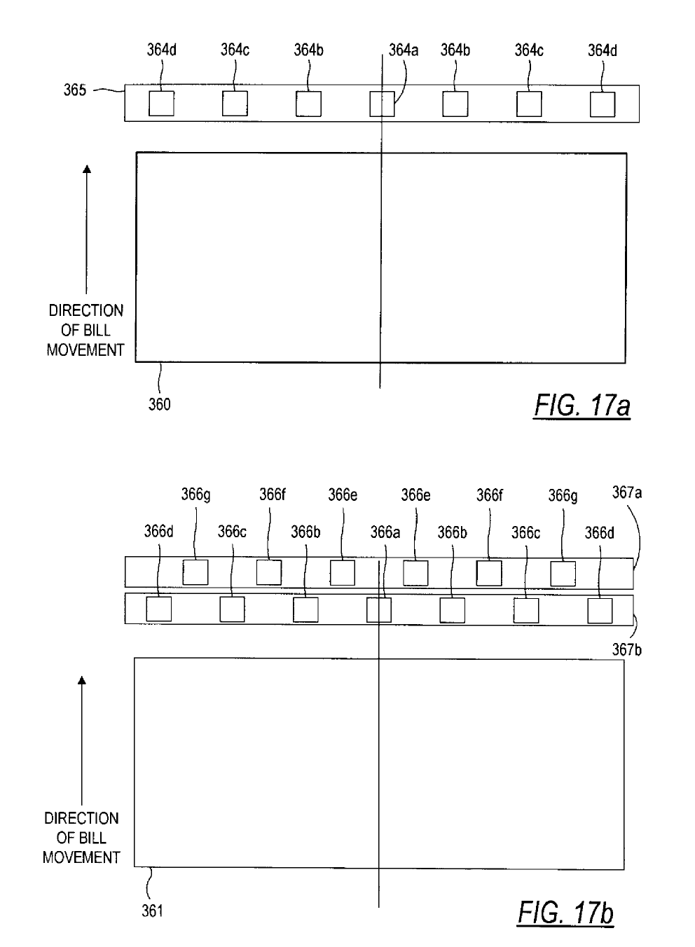

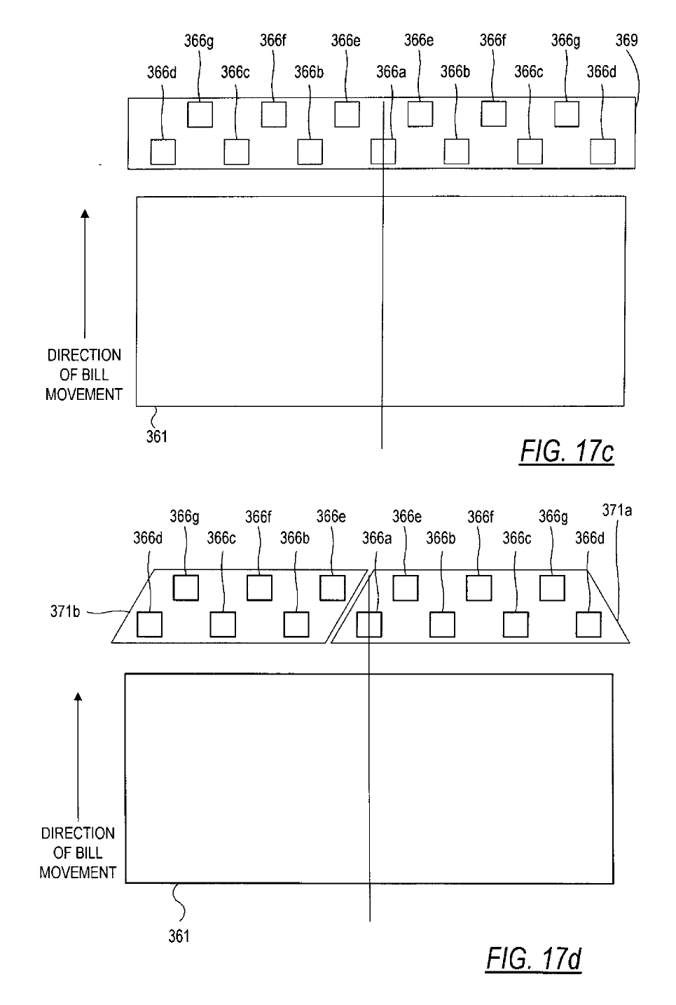

The sensors of FIGS. 13, 14, and 15 may be embodied as separate discrete sensors. Alternatively, two or more of these sensors may be embodied in the same scanhead or array structure. For example, FIG. 17a depicts the arrangement of FIG. 13a except that sensors 364a-d are arranged in a single scanhead 365. In a like manner, the sensors of FIGS. 13 and 14 may be arranged in one or more scanheads.

For example, the staggered arrangement of sensors 366 depicted in FIG. 14 may comprise two scanheads, each comprising a linear array of sensors (FIG. 17b, scanheads 367a, 367b). For example sensors 366a-d may be arranged in a first scanhead and sensors 366e-g may be arranged in a second scanhead. Other arrangements are illustrated in FIGS. 17c and 17d which include scanheads 369 and 371a and 271b. These scanheads of multiple sensors may comprise, for example, magnetoresistive sensors as described above.

Additionally, the location of the thread within the bill can be used as a security feature. For example, the security threads in all $100 bills are located in the same position. Furthermore, the location of the security threads in other denominations will be the same by denomination and will vary among several denominations. For example, the location of security threads in $10s, $20s, $50, and $100 may all be distinct. Alternatively, the location may be the same in the $20s and the $100s but different from the location of the security threads in the $50s. The use of security is not limited to U.S. currency bills; rather, many other currency denomination throughout the world incorporated security threads.

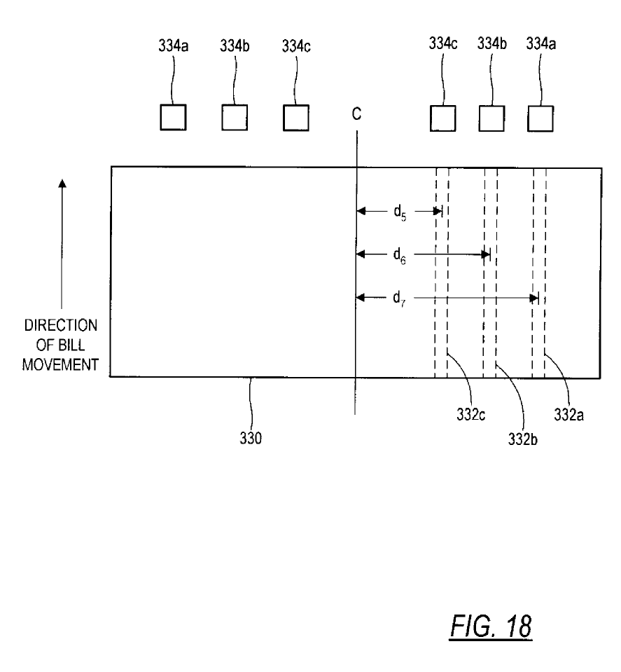

The presence of a security thread can be detected using magnetic sensing, optical sensing, or capacitance sensing. Optical sensing, including the use of ultra violet light, is disclosed in U.S. Pat. No. 5,992,601 incorporated by reference above. Referring to FIG. 18, a bill 330 is shown indicating three possible locations 332a-c for security threads in genuine bills depending on the denomination of the bill. Sensors 334a-c are positioned over the possible acceptable locations of security threads. In systems designed to accept bills fed in either the forward or the reverse direction, identical sensors are positioned over the same locations on each half of the bill. For example, sensors 334c are positioned a distance d₅ to the left and right of the center of the bill 330. Likewise, sensors 334b are positioned a distance d₆ to the left and right of the center of the bill 330 while sensors 334a are positioned a distance d₇ to the left and right of the center of the bill 330. Additional sensors may be added to cover additional possible thread locations. These sensors may be designed to detect the magnetic characteristic of the security threads.

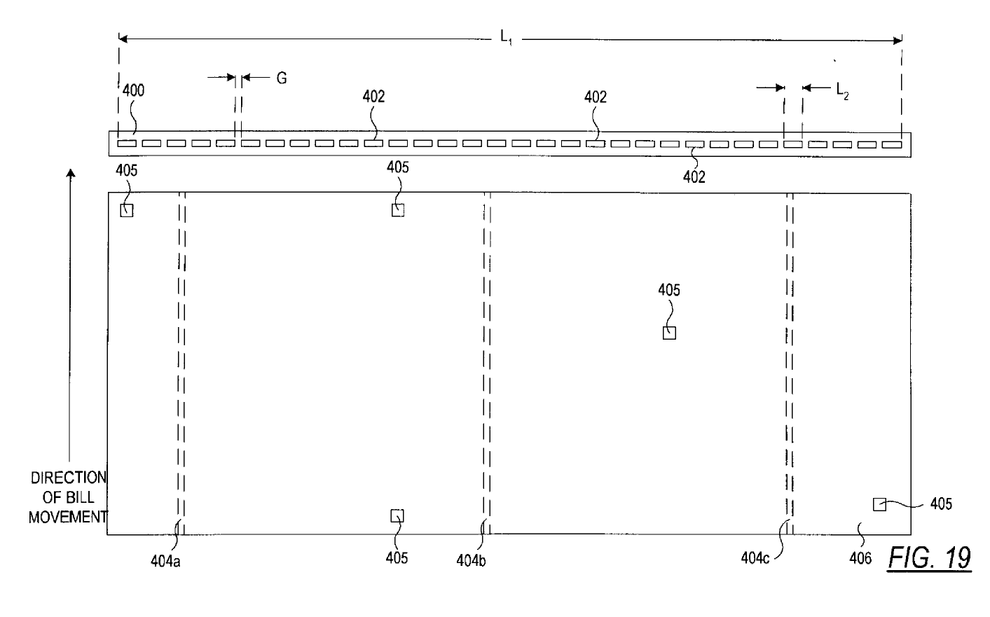

Referring now to FIG. 19, an embodiment of a “full array” magnetic scanhead 400 comprising thirty-two individual magnetic sensors 402 is illustrated. The illustrated embodiment of the magnetic scanhead 400 is capable of detecting a magnetic attribute(s) 405 of a currency bill disposed most anywhere throughout or within the currency bill. Examples of magnetic attributes of a currency bill may include security thread(s) 404a-c exhibiting magnetic properties, the aforementioned magnetic print zones including portions of serial numbers or barcodes printed on the bill. As discussed above, specific portions of U.S. currency bills are printed with ink exhibiting magnetic properties. U.K. pound notes and Mexican peso notes contain security threads exhibiting magnetic properties. The magnetic attributes of a currency bill need not be limited to security threads or magnetic printing but can include other objects having magnetic properties disposed within or on a currency bill. Examples of magnetic sensors which may be used in the magnetic scanhead are described in U.S. Pat. Nos. 5,086,519; 5,418,458; 5,552,589; 4,122,505; and 5,196,681, each of which is incorporated herein by reference in its entirety. The inventors use the term “full array” to describe a sensor or scanhead which substantially extends across the full length of the currency bill. The plurality of magnetic sensors 402 are closely spaced together to minimize the gap G—the physical space between individual sensors 402. Reducing the gap G between the individual sensors reduces the dead spots in the magnetic scanhead 400. Conversely, increasing the gap G between individual sensors 402 can create dead spots or “holes” such that a magnetic attribute passing through the dead space could not be detected. Therefore, it is desirable to minimize the gap G between sensors 402 so that the magnetic attributes 405 such as security threads, for example, in currency bills will not go undetected.

The proximate disposition of the sensors 402 increases the ability of the magnetic scanhead to detect the presence of a magnetic attribute 405 which is located at any position on or within the currency bill 406. In one embodiment of the magnetic scanhead 400, the sensors 402 are disposed at a distance such that the gap G between each of the sensors 402 is about one millimeter. In another embodiment, the sensors 402 are disposed at a distance such that the gap G is less than about one millimeter. In still another embodiment, the sensors 402 are disposed at a distance such that the gap G is about 0.5 mm. Applicants have found that disposing the sensors 402 such that the gap G is less than about one millimeter, e.g. about 0.5 mm, substantially eliminates dead spots from the scanhead 400. This embodiment of the magnetic scanhead is capable of detecting very discrete magnetic attributes of currency bills including attributes having a dimension less than about one millimeter. In one embodiment of the currency handing device 10, the distance between the magnetic scanhead 400 and the surface of the currency bill 406, termed the “air gap,” ranges between 0 inch and 0.040 inch. In other embodiments, the air gap is greater than 0.040 inch.

Using security threads as an example, the inventors have found that most security threads disposed within currency bills issued throughout the world, such as the Mexican 200 peso note, have a width of at least about one millimeter. Accordingly, where the length of the magnetic scanhead is substantially equal to the length of a currency bill and the sensors are positioned with close proximity as described, the magnetic scanhead 400 will be able to detect the presence of a magnetic attribute of the currency bill no matter where the magnetic attribute is positioned on or within the currency bill. Therefore, the currency handling device 10 employing the magnetic scanhead 400 is suited to process currency bills having magnetic attributes positioned most anywhere within the currency bills. Further, the currency processing device 10 equipped with the magnetic scanhead 400 is suited to processes new series of bills which may be introduced in the future, because the ability of the magnetic scanhead 400 to detect the presence of a magnetic attribute is not dependent on a sensor pre-positioned along a bill transport path corresponding to a known location on or within a currency bill. Rather, the same sensor can be used for currency from different countries having varying magnetic attributes locations.

The detection of a magnetic attribute of a currency bill is also not dependent on the direction of bill travel. For example, prior art sensors having larger dead spots may be able to detect the security threads 404 if the currency bill 406, illustrated in FIG. 19, was transported in a direction parallel to the long dimension of the currency bill 406. However, prior art sensors having large dead spots would be unable to detect the presence of a security thread 404 if the currency 406 was transported in the direction indicated. Most security threads are rather narrow and may pass through the large dead spots of prior art magnetic sensors. Additionally, a prior art magnetic sensor having large dead spots may be unable to detect smaller magnetic attributes 405 regardless of the direction of bill travel.

The magnetic scanhead can detect the presence of a magnetic attribute as well as determine the proximate location of the magnetic attribute relative to the dimension of the bill perpendicular to the direction of travel. For example, referring to FIG. 19, if the fourth (from let to right in FIG. 19) individual sensor 402 detected a magnetic attribute, the CPU of the device 10 can quickly determine the distance between the magnetic attribute and the left edge of the bill from the physical dimension of the bill. The locations of the magnetic attribute(s), the presence of the magnetic attribute(s), and/or the characteristics of the magnetic attribute(s) can be compared with master information during the evaluation of the currency bill.

To adapt a device 10 equipped with a scanhead 400 to handle a new set of currency, the device's 10 software can be simply reprogrammed to provide an indication of authenticity and/or denomination based on preprogrammed new magnetic attributes and their respective locations. Master attribute information can be stored in the system memory. In one embodiment, the system memory is in the form of an EPROM 34 (see FIGS. 2 and 3).

The inventors have found that a magnetic scanhead 400 having a scanning length L₁, from the left-most sensor 402 to the right-most sensor 402, of about 159.5 mm (about 6.28 inches) is suitable for processing currency of many denominations from many countries. According to one embodiment, each of the thirty-two sensors 402 have a length L₂ of about 4.5 mm (about 0.177 inch) with a center to center spacing of about 5 mm (0.197 inch) so that the gap G between sensors 402 is about 0.5 mm (about 0.020 inch).

The magnetic scanhead 400 is capable of scanning a substantially continuous segment of a currency bill because the close proximity of the sensors 402 effectively eliminates the dead spots from the magnetic scanhead 400. The inventors use the term “substantially continuous” to describe the effective elimination of dead spots from the magnetic scanhead 400. Put another way, the scanhead 400 can scan a magnetic attribute 405 (having dimension smaller than 1 mm) of a currency bill, such as a security thread, regardless of the location of the attribute within the segment of the currency bill being scanned. The width of the substantially continuous segment is dependant on the number of sensors employed in the scanhead 400. For example, if the scanhead 400 illustrated in FIG. 19 employed only two sensors 402 (rather than the thirty-two illustrated sensors 402), the scanhead would be able to substantially continuously scan a segment of a bill having a width of about 9.5 mm as the tip-to-tip length of the two sensor scanhead is about 9.5 mm (two 4.5 mm sensors with a center-to-center distance of 5 mm). Or, according to the embodiment illustrated in FIG. 19, the magnetic scanhead is able to substantially continuous scan a segment of a bill having a width of about 159.5 mm as the tip-to-tip length of the scanhead 400 is about 159.5 mm (thirty-two 4.5 mm sensors with a center-to-center distance of five mm.).

The sensors 402 of the magnetic scanhead 400 illustrated in FIG. 19 cover a substantial portion of the bill 406. Using U.S. currency as an example, U.S. currency bills have a long dimension of about 155 mm (6.1 inch). The scanhead 400 has length L₁ of 159.5 mm (about 6.28 inch) and a total sensor length (4.5 mm×32 sensors) of 144 mm (about 5.76 inch). Accordingly, a the ratio of the length of a U.S. currency bill to the combined length of the sensors is about 97%. Thus, the magnetic scanhead 400 to is able to cover a substantial portion of the long dimension of a U.S. currency bill.

The physical size of the magnetic scanhead and the individual sensors can vary according to various alternative embodiments of the present invention. For example, in one embodiment, each of the individual sensors 400 may have a length of eight millimeters. In an alternative embodiment, the scanhead may be made up of sixty-four sensors. Obviously, the physical dimensions of the sensors and scanhead can vary according to various alternative embodiments of the present invention.

In addition to the currency handling device 10 illustrated in FIG. 1, the full array magnetic scanhead 400, illustrated in FIG. 19, can be implemented into other currency and document evaluation devices. For example, the magnetic scanhead 400 can be implemented in bill accepting mechanisms often used with vending machines or bill changing machines. Other devices include point of sale devices for evaluating the authenticity of currency bills. Further, the magnetic scanhead 400 can be implemented in most any device for evaluating documents having subtle (very small) magnetic attributes.

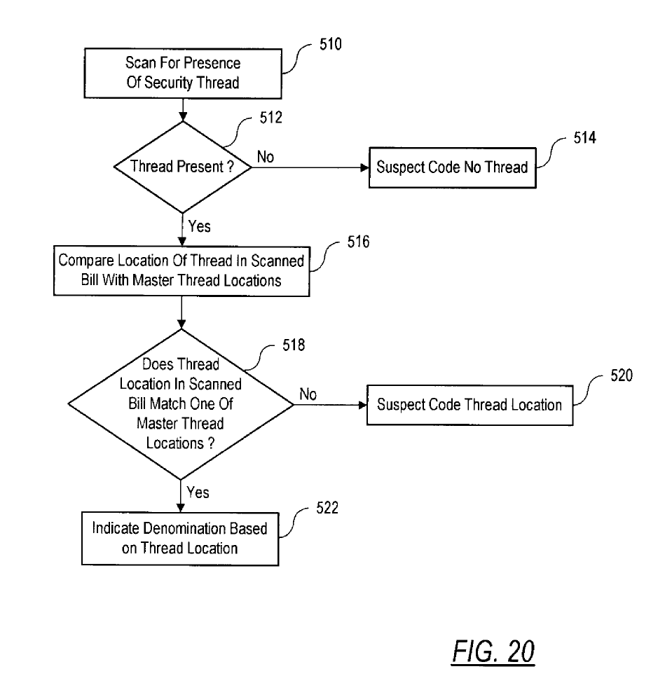

FIGS. 20-24 are flowcharts illustrating several methods for using optical, magnetic, and security thread information to denominate and authenticate bills. These methods may be employed with the various characteristic information detection techniques described above including, for example, those employing visible and ultraviolet light and magnetics including, for example, those for detecting various characteristics of security threads. Additionally, the currency handling device 10 with the magnetic scanhead 400 can scan a currency bill and generate a magnetic image of the bill. The magnetic image can be compared to master magnetic images obtained from known genuine bills stored in a memory of the device 10 to evaluate the currency bill.

FIG. 20 is a flowchart illustrating the steps performed in determining the denomination of a bill based on the location of a security thread. At step 510, a bill is scanned for the presence of a security thread. The presence of a security thread may be detected using a number of types of sensors such as optical sensors using transmitted and/or reflected light, magnetic sensors such as the full array magnetic scanhead illustrated in FIG. 19, and/or capacitive sensors. See, for example, U.S. Pat. Nos. 5,151,607 and 5,122,754. If a thread is not present as determined at step 512, a suspect code may be issued at step 514. This suspect code may indicate that no thread was detected if this level of detail is desirable. The lack of the presence of a thread resulting in a suspect code is particularly useful when all bills to be processed are expected to have a security thread therein. In other situations, the absence of a security thread may indicate that a scanned bill belongs to one or more denominations but not others. For example, assuming security threads are present in all genuine U.S. bills between $2 and $100 dollars, but not in genuine $1 bills, the absence of a security thread may be used to indicate that a scanned bill is a $1 bill. According to one embodiment, where it is determined that no security thread is present, a bill is preliminary indicated to be a $1 bill. Preferably, some additional test is performed to confirm the denomination of the bill such as the performance of the optical denominating methods. The optical denominating steps may be performed before or after the thread locating test. If at step 512 it is determined that a security thread is present, the location of the detected security thread is then compared with master thread locations associated with genuine bills at step 516. At step 518 it is determined whether as a result of the comparison at step 516 the detected thread location matches one of the stored master thread locations. If the detected thread location does not sufficiently match one of the stored master thread locations, an appropriate suspect code is generated at step 520. This suspect code may indicate that detected thread was not in an acceptable location if such information is desirable. Otherwise, if the detected thread location does sufficiently match one of the stored master thread locations, the denomination associated with the matching master thread location is indicated as the denomination of the scanned bill at step 522. In other embodiments, the device 10 is capable of processing many different types of currency including, for example, casino script and transit passes as well as currency issued by different countries.

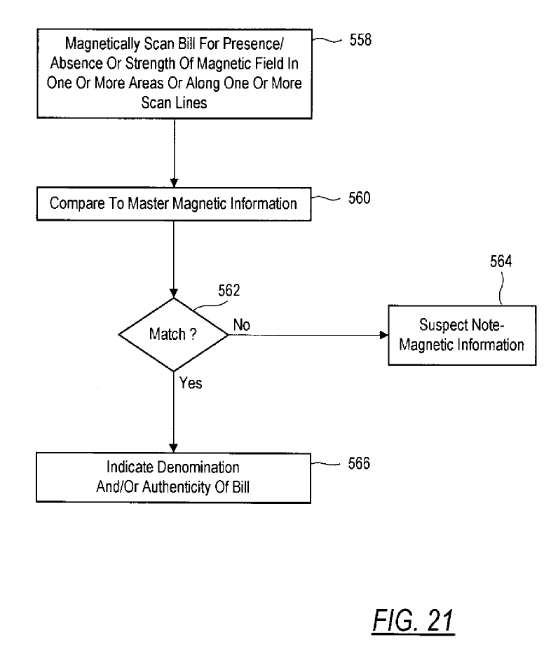

FIG. 21 is a flowchart illustrating the steps performed in magnetically determining the denomination of a bill. At step 558, a bill is magnetically scanned and one or more magnetic patterns are generated. Patterns generated may be, for example, patterns of magnetic field strength. Alternatively, instead of generating magnetically scanned patterns, a bill is magnetically scanned for the presence or absence of magnetic ink at one or more specific locations on the bill. Alternatively, instead of simply detecting whether magnetic ink is present at certain locations, the strength of magnetic fields may be measured at one or more locations on the bill. At step 560 the scanned magnetic information is compared to master magnetic information. One or more sets of master magnetic information are stored for each denomination that a system employing the methods of FIG. 21 is designed to discriminate. For example, where one or more scanned magnetic patterns are generated, such patterns are compared to stored master magnetic patterns. Where, the presence or absence of magnetic ink is detected at various locations on a bill, this information is compared to the stored master magnetic information associated with the expected presence and absence of magnetic ink characteristics at these various locations for one or more denominations of genuine bills. Alternatively, measured field strength information can be compared to master field strength information. At step 562 it is determined whether as a result of the comparison of step 560 the scanned magnetic information sufficiently matches one of sets of stored master magnetic information. For example, the comparison of patterns may yield a correlation number for each of the stored master patterns. To sufficiently match a master pattern, it may be required that the highest correlation number be greater than a threshold value. An example of such a method as applied to optically generated patterns is described in more detail in U.S. Pat. No. 5,295,196 incorporated herein by reference. If the scanned magnetic information does not sufficiently match the stored master magnetic information, an appropriate suspect code is generated at step 564. Otherwise, if the scanned magnetic information does sufficiently match one of the sets of stored master magnetic information, the denomination associated with the matching set of master magnetic information is indicated as the denomination of the scanned bill at step 566.

FIG. 22 is a flowchart illustrating the steps performed in optically denominating a bill and magnetically authenticating the bill. At step 588, a bill is optically denominated, for example, according to the methods described above in U.S. Pat. No. 5,992,601, incorporated herein by reference above. Provided the denomination of the bill is optically determined at step 588, the bill is then magnetically authenticated at step 590. The magnetic authentication step 590 may be performed, for example, according to the methods described in connection with in FIG. 21. At step 590, however, the detected magnetic information is only compared to master magnetic information associated with the denomination determined in step 588. If the master magnetic information for the denomination indicated in step 588 matches (step 592) the detected magnetic information for the bill under test, the bill is accepted (at step 596) as being a bill having the denomination determined in step 588. Otherwise, an appropriate suspect code is issued at step 594.

FIG. 23 is a flowchart illustrating the steps performed in magnetically denominating a bill and optically authenticating the bill. At step 598, a bill is magnetically denominated, for example, according to the methods described above in connection with FIG. 21. Provided the denomination of the bill is magnetically determined at step 598, the bill is then optically authenticated at step 600. The optical authentication step 600 may be performed, for example, according to the methods described in above in U.S. Pat. No. 5,992,601, incorporated herein by reference above. At step 600, however, the detected optical information (or pattern) is only compared to master optical information (or pattern or patterns) associated with the denomination determined in step 598. If the master optical information for the denomination indicated in step 598 matches (step 602) the detected optical information for the bill under test, the bill is accepted (at step 606) as being a bill having the denomination determined in step 598. Otherwise, an appropriate suspect code is issued at step 604.

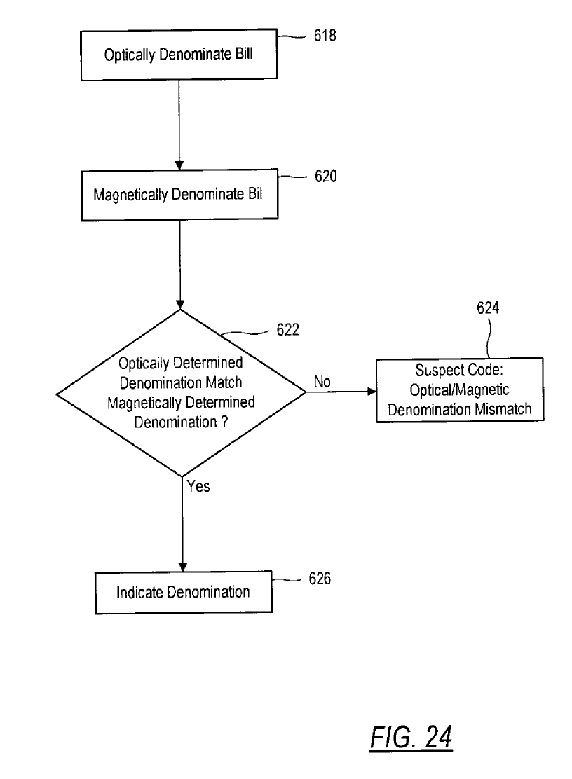

FIG. 24 is a flowchart illustrating the steps performed in denominating a bill both optically and magnetically. At step 618, a bill is optically denominated, for example, according to the methods described above in connection with FIG. 25. Provided the denomination of the bill is optically determined at step 618, the bill is then denominated magnetically at step 620, for example, according to the methods described in connection with FIG. 21. At step 620, the magnetic denominating is performed independently of the results of the optical denominating step 618. At step 622, the denomination as determined optically is compared with the denomination as determined magnetically. If both optical and magnetic denominating steps indicate the same denomination, the bill is accepted (at step 626) as being a bill having the denomination determined in steps 618 and 620. Otherwise, an appropriate suspect code is issued at step 624. Alternatively, the order of steps 618 and 620 may be reversed such that the bill is first magnetically denominated and then optically denominated.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

1. A method of denominating a currency bill printed using magnetic zone printing as belonging to one of a plurality of recognizable denominations using a currency evaluation device, each of the recognizable denominations having a unique magnetic zone printing configuration, comprising:
receiving a stack of bills in an input receptacle of the currency evaluation device, the bills being rectangular and having a long dimension and a narrow dimension;
transporting the bills, one at a time, along a transport direction from the input receptacle past a plurality of magnetic sensors, transporting the bills with their narrow dimension parallel to the transport direction;
detecting the presence or absence of magnetic ink in a plurality of zones on a currency bill under the control of a currency denominating device, said plurality of zones being selected to provide information sufficient to discriminate among the plurality of recognizable denominations based on the presence or absence of magnetic ink in said zones; and
denominating said currency bill as belonging to one of the plurality of recognizable denominations under the control of said currency denominating device by comparing the detected information concerning which zones contained magnetic ink and which zones did not contain magnetic ink to master information stored by said currency denominating device defining for each of the recognizable denominations the zones in which magnetic ink is expected and the zones in which magnetic ink is not expected.

2. The method of claim 1 wherein the plurality of magnetic sensors are closely spaced and linearly aligned.

3. The method of claim 2 wherein the scanhead is disposed transverse to the document transport path.

4. The method of claim 2 wherein the spacing between each of the plurality of magnetic sensors is about one millimeter.

5. The method of claim 2 wherein the spacing between each of the plurality of sensors is less than about one millimeter.

6. The method of claim 1 wherein the bills are denominated at a rate of at least 800 bills per minute.

7. A currency evaluation device for receiving a stack of currency bills and rapidly evaluating all the bills in the stack, the device comprising:
an input receptacle for receiving a stack of bills to be evaluated;
at least one output receptacle for receiving the bills after each of the bills have been evaluated;
a transport mechanism for transporting the bills, one at a time, from the input receptacle to the at least one output receptacle along a transport path;
a magnetic scanhead disposed adjacent to the transport path, the scanhead including a plurality of closely spaced magnetic sensors each adapted to detect the presence of a security thread within the bills, the scanhead being adapted to determine the location of the security thread within the bill;
a memory adapted to store master security thread location information corresponding to a plurality of denominations of currency bills; and
an evaluating unit adapted to determine the denomination of the currency bill when the determined security thread location favorably compares to the master security thread location information, the evaluating unit being adapted to generate an error signal when the determined security thread location does not favorably compare to master security thread location information.

8. The currency evaluation device of claim 7 wherein the plurality of sensors are linearly aligned within the scanhead.

9. The currency evaluation device of claim 8 wherein scanhead is disposed transverse to the document transport path.

10. The currency evaluation device of claim 9 wherein the spacing between each of the plurality of sensors is about one millimeter.

11. The currency evaluation device of claim 9 wherein the spacing between each of the plurality of sensors is less than about one millimeter.

12. The currency evaluation device of claim 7 wherein the transport mechanism is adapted to transport each of the bills such that a long edge of the bill is the leading edge of the bill.

13. The currency evaluation device of claim 7 wherein the bills are evaluated at a rate of at least 800 bills per minute.

14. A currency evaluation device for receiving a stack of currency bills and rapidly evaluating all the bills in the stack, the device comprising:
an input receptacle for receiving a stack of bills to be evaluated;
at least one output receptacle for receiving the bills after each of the bills have been evaluated;
a transport mechanism for transporting the bills, one at a time, from the input receptacle to the at least one output receptacle along a transport path;
a magnetic scanhead disposed adjacent to the transport path, the scanhead including a plurality of closely spaced magnetic sensors, each of the magnetic sensors being adapted to detect magnetic zone printing configuration information from each of the currency bills, each of the magnetic sensors adapted to detect the presence of a security thread within each of the bills, the magnetic scanhead being adapted to determine the location of a detected security thread within a currency bill;
a memory adapted to store master magnetic zone printing configuration information and master security thread location information; and
an evaluating unit adapted to determine the denomination of each of the bills by comparing the detected magnetic zone printing configuration information to the stored master magnetic zone printing configuration information, the evaluating unit being adapted to authenticate each of the currency bills by comparing the determined security thread location to the stored master security thread location information.

15. The currency evaluation device of claim 14 wherein the plurality of sensors are linearly aligned within the scanhead.

16. The currency evaluation device of claim 15 wherein scanhead is disposed transverse to the document transport path.

17. The currency evaluation device of claim 16 wherein the spacing between each of the plurality of sensors is about one millimeter.

18. The currency evaluation device of claim 16 wherein the spacing between each of the plurality of sensors is less than about one millimeter.

19. The currency evaluation device of claim 14 wherein the transport mechanism is adapted to transport each of the bills such that a long edge of the bill is the leading edge of the bill.

20. The currency evaluation device of claim 14 wherein the bills are evaluated at a rate of at least 800 bills per minute.

21. A currency evaluation device for evaluating different types of currency bills including currency from different counties:
an input receptacle for receiving a stack of bills to be evaluated;
at least one output receptacle for receiving the bills after each of the bills have been evaluated;
a transport mechanism for transporting the bills, one at a time, from the input receptacle to the at least one output receptacle along a transport path;
a magnetic scanhead disposed adjacent to the transport path, the scanhead including a plurality of closely spaced magnetic sensors, each of the magnetic sensors being adapted to detect the presence of a security thread within each of the bills, the magnetic scanhead being adapted to determine the location of the detected security thread within a bill;
a memory adapted to store a plurality of master security thread information corresponding to a plurality of types of currency, the master security thread information defining a predetermined number of security thread locations for each of the plurality of currency types, the predetermined number corresponding to the number of denominations of bills in a particular currency type; and
an evaluating unit adapted to evaluate each of the bills by comparing the determined security thread location to the master security thread location information corresponding to the type of currency, the evaluating unit being adapted to generate an error signal when the determined security thread location information does not favorably compare to one of the security locations for the particular currency type specified by the user.

22. The currency evaluation device of claims 21 wherein the evaluating unit is adapted to determine the type of currency being evaluated from among a plurality of currency types, the plurality of currency types corresponding to currency issued by a plurality of countries.

23. The currency evaluation device of claim 21 further comprising a user interface adapted to receive information form a user of the currency evaluation device specifying the type of currency to be processed.

24. The currency evaluation device of claim 21 wherein the plurality of sensors are linearly aligned within the scanhead.

25. The currency evaluation device of claim 24 wherein scanhead is disposed transverse to the document transport path.

26. The currency evaluation device of claim 25 wherein the spacing between each of the plurality of sensors is about one millimeter.

27. The currency evaluation device of claim 25 wherein the spacing between each of the plurality of sensors is less than about one millimeter.

28. The currency evaluation device of claim 21 wherein the transport mechanism is adapted to transport each of the bills such that a long edge of the bill is the leading edge of the bill.

29. The currency evaluation device of claim 21 wherein the bills are evaluated at a rate of at least 800 bills per minute.

30. A method of rapidly evaluating currency bills with a currency evaluation device, the method comprising:
receiving a stack of currency bills in an input receptacle;
transporting each of the bills from the input receptacle, one at a time, past a magnetic scanhead to at least one output receptacle, the magnetic scanhead including plurality of closely spaced magnetic sensors;
detecting the presence of a security thread disposed within each of the bills with the magnetic scanhead; and
generating an error signal when the presence of a security thread is not detected.

31. The method of claim 30 wherein the plurality of magnetic sensors are linearly aligned within the magnetic scanhead.

32. The method of claim 31 wherein the scanhead is disposed transverse to the document transport path.

33. The method of claim 32 wherein the spacing between each of the plurality of magnetic sensors is about one millimeter.

34. The method of claim 32 wherein the spacing between each of the plurality of sensors is less than about one millimeter.

35. The method of claim 30 wherein transporting each of the bills further comprises transporting each of the bills such that a long edge of the bill is the leading edge of the bill.

36. The method of claim 30 wherein the bills are evaluated at a rate of at least 800 bills per minute.

37. A method of rapidly authenticating currency bills with a currency evaluation device, the method comprising:
receiving a stack of currency bills in an input receptacle;
transporting each of the bills from the input receptacle, one at a time, past a magnetic scanhead to at least one output receptacle, the magnetic scanhead including a plurality of closely spaced magnetic sensors;
detecting the presence of a security thread disposed within each of the bills with the magnetic scanhead;
determining the location of the detected security thread within each of the bills with the magnetic scanhead; and
generating an error signal when the determined security thread location does not favorably compare to master security thread location information stored in a memory of the currency evaluation device.

38. The method of claim 37 wherein the plurality of magnetic sensors are linearly aligned within the scanhead.

39. The method of claim 38 wherein the scanhead is disposed transverse to the document transport path.

40. The method of claim 38 wherein the spacing between each of the plurality of magnetic sensors is about one millimeter.

41. The method of claim 38 wherein the spacing between each of the plurality of sensors is less than about one millimeter.

42. The method of claim 37 wherein transporting each of the bills further comprises transporting each of the bills such that a long edge of the bill is the leading edge of the bill.

43. The method of claim 37 wherein the bills are evaluated at a rate of at least 800 bills per minute.

44. A method of rapidly evaluating currency bills with a currency evaluation device, the method comprising:
receiving a stack of currency bills in an input receptacle;
transporting each of the bills from the input receptacle, one at a time, past a magnetic scanhead having a plurality of closely spaced magnetic sensors;
detecting magnetic zone printing configuration information from each of the bills with the magnetic scanhead;
detecting the presence of a security thread disposed within each of the bills with the magnetic scanhead;
determining the location of the detected security threads within each of the bills;
denominating each of the currency bills by comparing the detected magnetic zone printing configuration information from each of the bills to master magnetic zone printing configuration information stored in a memory of the currency handling device; and
authenticating each of the currency hills by comparing the determined location of the detected security thread within each of the bills to master security thread information stored in the memory of the currency handling device.

45. The method of claim 44 wherein the plurality of magnetic sensors are linearly aligned within the scanhead.

46. The method of claim 45 wherein the scanhead is disposed transverse to the document transport path.

47. The method of claim 46 wherein the spacing between each of the plurality of magnetic sensors is about one millimeter.

48. The method of claim 46 wherein the spacing between each of the plurality of sensors is less than about one millimeter.

49. The method of claim 44 wherein transporting each of the bills further comprises transporting each of the bills such that a long edge of the bill is the leading edge of the bill.

50. The method of claim 44 wherein the bills are evaluated at a rate of at least 800 bills per minute.

51. A method of rapidly evaluating currency bills of different types including currency bills from different countries with a currency evaluation device, the method comprising:
receiving a stack of a particular type of currency bills in an input receptacle;
transporting each of the bills from the input receptacle, one at a time, past a magnetic scanhead having a plurality of closely spaced magnetic sensors;
determining the type of currency being evaluated from among a plurality of currency types, the plurality of currency types corresponding to currency issued by a plurality of countries;
detecting the presence of a security thread disposed within each of the bills with the magnetic scanhead;
determining the location of the detected security thread within each of the bills;
evaluating each of the currency bills by comparing the determined security thread location to master security thread location information corresponding to a plurality of types of currency bills, the master security thread information defining a predetermined number of security thread locations for each of the plurality of currency types, the predetermined number corresponding to the number of denominations of bills in a particular currency type; and
generating an error signal when the determined security thread location information does not favorably compare one of the security locations for the particular currency type specified by the user.

52. The method of claim 51 wherein the plurality of magnetic sensors are linearly aligned within the scanhead.

53. The method of claim 52 wherein the scanhead is disposed transverse to the document transport path.

54. The method of claim 53 wherein the spacing between each of the plurality of magnetic sensors is about one millimeter.

55. The method of claim 53 wherein the spacing between each of the plurality of sensors is less than about one millimeter.

56. The method of claim 51 wherein transporting each of the bills further comprises transporting each of the bills such that a long edge of the bill is the leading edge of the bill.

57. The method of claim 51 wherein the bills are evaluate at a rate of at least 800 bills per minute.

58. A currency evaluation device for receiving a currency bill having a magnetic attribute and evaluating the currency bill, the device comprising:
a magnetic scanhead disposed adjacent to a bill evaluation region, the scanhead including a plurality of closely spaced magnetic sensors each adapted to detect the presence of a magnetic attribute of the bill, the plurality of magnetic sensors covering a substantial portion of a dimension of a bill, the scanhead being adapted to retrieve magnetic characteristic information from the currency bill;
a memory adapted to store master magnetic characteristic information corresponding to a plurality of types of currency bills; and
an evaluating unit adapted to evaluate the currency bill by comparing the retrieved magnetic characteristic information to the stored master magnetic characteristic information, the plurality of magnetic sensors covering a substantial portion of a dimension of a bill, the evaluating unit being adapted to generate an error signal when the retrieved magnetic characteristic information does not favorably compare to the stored master magnetic characteristic information.

59. The currency evaluation device of claim 58 wherein the plurality of sensors are linearly aligned within the scanhead.

60. The currency evaluation device of claim 59 wherein scanhead is disposed transverse to the document transport path.

61. The currency evaluation device of claim 60 wherein the spacing between each of the plurality of sensors is less than about five millimeters.

62. The currency evaluation device of claim 60 wherein the spacing between each of the plurality of sensors is less than about four millimeters.

63. The currency evaluation device of claim 60 wherein the spacing between each of the plurality of sensors is less than about three millimeters.

64. The currency evaluation device of claim 60 wherein the spacing between each of the plurality of sensors is less than about two millimeters.

65. The currency evaluation device of claim 60 wherein the spacing between each of the plurality of sensors is about one millimeter.

66. The currency evaluation device of claim 60 wherein the spacing between each of the plurality of sensors is less than about one millimeter.

67. The currency evaluation device of claim 60 wherein the spacing between each of the plurality of sensors is about 0.5 millimeter.

68. A document evaluation device comprising:
a magnetic scanhead disposed adjacent to a document evaluation region and adapted to scan a document along a dimension of the document, the scanhead including a plurality of closely spaced magnetic sensors each adapted to detect the presence of a magnetic attribute of the document, the plurality of magnetic sensors covering a substantial portion of a dimension of a document, the scanhead being adapted to retrieve characteristic magnetic information from the currency document;
a memory adapted to store master magnetic attribute information; and
an evaluating unit adapted to evaluate the document bill by comparing the received characteristic magnetic information to the stored master magnetic characteristic information, the evaluating unit being adapted to generate an error signal when the received characteristic magnetic information does not favorably compare to the stored master magnetic characteristic information.

69. The currency evaluation device of claim 68 wherein the plurality of sensors are linearly aligned within the scanhead.

70. The currency evaluation device of claim 69 wherein scanhead is disposed transverse to the document transport path.

71. The currency evaluation device of claim 70 wherein the spacing between each of the plurality of sensors is less than about five millimeters.

72. The currency evaluation device of claim 70 wherein the spacing between each of the plurality of sensors is less than about four millimeters.

73. The currency evaluation device of claim 70 wherein the spacing between each of the plurality of sensors is less than about three millimeters.

74. The currency evaluation device of claim 70 wherein the spacing between each of the plurality of sensors is less than about two millimeters.

75. The currency evaluation device of claim 70 wherein the spacing between each of the plurality of sensors is about one millimeter.

76. The currency evaluation device of claim 70 wherein the spacing between each of the plurality of sensors is less than about one millimeter.

77. The currency evaluation device of claim 70 wherein the spacing between each of the plurality of sensors is about 0.5 millimeter.

78. A currency evaluation device for receiving a currency bill having a magnetic attribute and evaluating the currency bill, the device comprising:
an inlet for receiving a currency bill to be evaluated;
an output receptacle for receiving the bill after the bill has been evaluated;
a transport mechanism for transporting the bill from the inlet to the output receptacle along a transport path;
a magnetic scanhead disposed adjacent to the transport path, the scanhead including a plurality of linearly aligned and closely spaced magnetic sensors, the scanhead being adapted to detect the presence of a magnetic attribute of the bill when the magnetic attribute has a leading edge dimension greater than about one millimeter, the plurality of magnetic sensors covering a substantial portion of a dimension of the bill, the scanhead being adapted to retrieve characteristic magnetic information from the currency bill, the scanhead disposed transverse the transport path;
a memory adapted to store master magnetic characteristic information corresponding to a plurality of types of currency bills; and
an evaluating unit adapted to evaluate the currency bill by comparing the retrieved magnetic characteristic information to the stored master magnetic characteristic information, the evaluating unit being adapted to generate an error signal when the retrieved characteristic magnetic information does not favorably compare to the stored master magnetic characteristic information.

79. The currency evaluation device of claim 78 wherein the plurality of sensors are linearly aligned within the scanhead.

80. The currency evaluation device of claim 78 wherein scanhead is disposed transverse to the document transport path.

81. The currency evaluation device of claim 80 wherein the spacing between each of the plurality of sensors is less than about five millimeters.

82. The currency evaluation device of claim 80 wherein the spacing between each of the plurality of sensors is less than about four millimeters.

83. The currency evaluation device of claim 80 wherein the spacing between each of the plurality of sensors is less than about three millimeters.

84. The currency evaluation device of claim 80 wherein the spacing between each of the plurality of sensors is less than about two millimeters.

85. The currency evaluation device of claim 80 wherein the spacing between each of the plurality of sensors is about one millimeter.

86. The currency evaluation device of claim 80 wherein the spacing between each of the plurality of sensors is less than about one millimeter.

87. The currency evaluation device of claim 80 wherein the spacing between each of the plurality of sensors is about 0.5 millimeter.

88. The currency evaluation device of claim 78 wherein the transport mechanism is adapted to transport each of the bills such that a long edge of the bill is the leading edge of the bill.

89. The currency evaluation device of claim 78 wherein the bills are evaluated at a rate of at least 800 bills per minute.

90. A method of rapidly authenticating currency bills with a currency evaluation device, the method comprising:
receiving a stack of currency bills in an input receptacle;
transporting each of the bills from the input receptacle, one at a time, past a magnetic scanhead to at least one output receptacle, the magnetic scanhead including a plurality of closely spaced magnetic sensors, the plurality of magnetic sensors covering a substantial portion of a dimension of the bill;
detecting the presence of a magnetic attribute of each of the bills with the magnetic scanhead;
retrieving magnetic characteristic information from each of the bills with the magnetic scanhead; and
generating an error signal when the retrieved magnetic characteristic information does not favorably compare to master magnetic characteristic information stored in a memory of the currency evaluation device.

91. The method of claim 90 further comprising linearly aligning the plurality of magnetic sensors within the scanhead.

92. The method of claim 91 further comprising disposing the scanhead transverse to the document transport path.

93. The method of claim 92 wherein linearly aligning further comprises linearly aligning the plurality of sensors within the scanhead such that the spacing between each of the sensors is less than about five millimeters.

94. The method of claim 92 wherein linearly aligning further comprises linearly aligning the plurality of sensors within the scanhead such that the spacing between each of the sensors is less than about four millimeters.

95. The method of claim 92 wherein linearly aligning further comprises linearly aligning the plurality of sensors within the scanhead such that the spacing between each of the sensors is less than about three millimeters

96. The method of claim 92 wherein linearly aligning further comprises linearly aligning the plurality of sensors within the scanhead such that the spacing between each of the sensors is less than about two millimeters.

97. The method of claim 92 wherein linearly aligning further comprises linearly aligning the plurality of sensors within the scanhead such that the spacing between each of the sensors is about one millimeter.

98. The method of claim 92 wherein linearly aligning further comprises linearly aligning the plurality of sensors within the scanhead such that the spacing between each of the sensors is less than about one millimeter.

99. The method of claim 92 wherein linearly aligning further comprises linearly aligning the plurality of sensors within the scanhead such that the spacing between each of the sensors is about 0.5 millimeter

100. The method of claim 90 wherein transporting each of the bills further comprises transporting each of the bills such that a long edge of the bill is the leading edge of the bill.

101. The method of claim 90 wherein the bills are evaluated at a rate of at least 800 bills per minute.

102. A magnetic scanhead for a currency evaluation device, the magnetic scanhead comprising at least two closely spaced magnetic sensors each adapted to detect the presence of a magnetic attribute of a currency bill, the scanhead being adapted to scan a substantially continuous segment of a bill along a dimension of the bill, the segment having a width substantially equivalent to a tip-to-tip length of the at least two sensors, the scanhead being adapted to retrieve magnetic characteristic information from the currency bills within the continuous segment.

103. The magnetic scanhead of claim 102 wherein each of at least two sensors have a length of abut 4.5.

104. The magnetic scanhead of claim 102 wherein the spacing between each of the at least two magnetic sensors is less than about one millimeter.

105. The magnetic scanhead of claim 102 wherein the spacing between each of the at least two magnetic sensors is about one millimeter.

106. The magnetic scanhead of claim 105 wherein the tip-to-tip length of the at least two sensors is about 9.5 millimeters

107. The magnetic scanhead of claim 102 wherein the at least two magnetic sensors are linearly aligned within the scanhead.

108. The magnetic scanhead of claim 102 wherein the at least two magnetic sensors comprise sixteen magnetic sensors.

109. The magnetic scanhead of claim 108 wherein the tip-to-tip length of the sixteen magnetic sensors is about 79.5 millimeters.

110. The magnetic scanhead of claim 102 wherein at least two magnetic sensors comprise thirty-two magnetic sensors.

111. The magnetic scanhead of claim 107 wherein the tip-to-tip length of the thirty-two magnetic sensors is about 159.5 millimeters.

112. A sensor arrangement for evaluating currency bills having a magnetic characteristic contained therein, the sensor arrangement comprising a plurality of spaced apart magnetic sensors arranged within a currency evaluating device in a manner such that the plurality of sensors collectively scan a substantially continuous segment of each of the currency bills transported along a bill transport path within the currency evaluating device.

113. The sensor arrangement of claim 112 wherein the distance between adjacent magnetic sensors is less than about five millimeters.

114. The sensor arrangement of claim 112 wherein the distance between adjacent magnetic sensors is less than about four millimeters.

115. The sensor arrangement of claim 112 wherein the distance between adjacent magnetic sensors is less than about three millimeters.

116. The sensor arrangement of claim 112 wherein the distance between adjacent magnetic sensors is less than about two millimeters.

117. The sensor arrangement of claim 112 wherein the distance between adjacent magnetic sensors is about one millimeter.

118. The sensor arrangement of claim 112 wherein the distance between adjacent magnetic sensors is less than about one millimeter.

119. The sensor arrangement of claim 112 wherein the distance between adjacent magnetic sensors is less than about 0.5 millimeter.

120. The sensor arrangement of claim 112 wherein the substantially continuous segment scanned collectively by the plurality of magnetic sensors has a dimension of at least about 9.5 millimeters in a direction transverse to the bill transport path.

121. The sensor arrangement of claim 112 wherein the substantially continuous segment scanned collectively by the plurality of magnetic sensors has a dimension of at least about 29.5 millimeters in a direction transverse to the bill transport path.

122. The sensor arrangement of claim 112 wherein the substantially continuous segment scanned collectively by the plurality of magnetic sensors has a dimension of at least about 59.5 millimeters in a direction transverse to the bill transport path.

123. The sensor arrangement of claim 112 wherein the substantially continuous segment scanned collectively by the plurality of magnetic sensors has a dimension of at least about 79.5 millimeters in a direction transverse to the bill transport path.

124. The sensor arrangement of claim 112 wherein the substantially continuous segment scanned collectively by the plurality of magnetic sensors has a dimension of at least about 159.5 millimeters in a direction transverse to the bill transport path.

125. The sensor arrangement of claim 112 wherein the substantially continuous segment scanned collectively by the plurality of magnetic sensors has a dimension of at least about 170 millimeters in a direction transverse to the bill transport path.

126. The sensor arrangement of claim 112 wherein the plurality of magnetic sensors are positioned in a substantially linear arrangement.

127. The sensor arrangement of claim 126 wherein the substantially liner arrangement is disposed substantially parallel to a long edge of currency bills transported within a currency evaluating device.

128. The sensor arrangement of claim 126 wherein the linear arrangement is arranged substantially parallel to a leading edge of currency bills transported within the currency evaluating device.

129. A method of evaluating currency bills having a magnetic characteristic contained therein, the method comprising:
arranging a plurality of magnetic sensors in a spaced apart orientation within a currency evaluating device;
transporting each of the currency bills along a bill transport path within the currency evaluating device; and
scanning a substantially continuous segment of each of the bills with the plurality of magnetic sensors.

130. The method claim 129 wherein arranging a plurality of magnetic sensors further comprises spacing each of the magnetic sensors apart from adjacent magnetic sensors by a distance of less than about five millimeters.

131. The method claim 129 wherein arranging a plurality of magnetic sensors further comprises spacing each of the magnetic sensors apart from adjacent magnetic sensors by a distance of less than about four millimeters.

132. The method claim 129 wherein arranging a plurality of magnetic sensors further comprises spacing each of the magnetic sensors apart from adjacent magnetic sensors by a distance of less than about three millimeters.

133. The method claim 129 wherein arranging a plurality of magnetic sensors further comprises spacing each of the magnetic sensors apart from adjacent magnetic sensors by a distance of less than about two millimeters.

134. The method claim 129 wherein arranging a plurality of magnetic sensors further comprises spacing each of the magnetic sensors apart from adjacent magnetic sensors by a distance of about one millimeter.

135. The method claim 129 wherein arranging a plurality of magnetic sensors further comprises spacing each of the magnetic sensors apart from adjacent magnetic sensors by a distance of less than about one millimeter.

136. The method claim 129 wherein arranging a plurality of magnetic sensors further comprises spacing each of the magnetic sensors apart from adjacent magnetic sensors by a distance of about 0.5 millimeter.

137. The method of claim 129 wherein scanning further comprises scanning a substantially continuous segment having a dimension of at least about 9.5 millimeters in a direction transverse to the bill transport path within the currency evaluating device.

138. The method of claim 129 wherein scanning further comprises scanning a substantially continuous segment having a dimension of at least about 29.5 millimeters in a direction transverse to the bill transport path.

139. The method of claim 129 wherein scanning further comprises scanning a substantially continuous segment having a dimension of at least about 59.5 millimeters in a direction transverse to the bill transport path.

140. The method of claim 129 wherein scanning further comprises scanning a substantially continuous segment having a dimension of at least about 79.5 millimeters in a direction transverse to the bill transport path.

141. The method of claim 129 wherein scanning further comprises scanning a substantially continuous segment having a dimension of at least about 159.5 millimeters in a direction transverse to the bill transport path.

142. The method of claim 129 wherein scanning further comprises scanning a substantially continuous segment having a dimension of at least about 170 millimeters in a direction transverse to the bill transport path.

143. The method of claim 129 wherein arranging further comprises arranging the plurality of magnetic sensors in a substantially linear arrangement.

144. The method of claim 143 wherein arranging further comprises disposing the linear arrangement of magnetic sensors substantially parallel to the long edge of currency bills being transported along the bill transport.

145. The method of claim 143 wherein arranging further comprises disposing the liner arrangement of magnetic sensors substantially parallel to the leading edge of currency bills being transport along the bill transport path.
